(19) United States
(12) Patent Application Publication
(10) Pub. No.: US 2012/0084120 A1
(43) Pub. Date: Apr. 5, 2012

(54) SURVEY ASSESSMENT

(75) Inventors: Guy Pinchas Hirsch, San Francisco, CA (US); Mariya Genzel, Mountain View, CA (US)

(73) Assignee: SayHired, Inc., San Bruno, CA (US)

(21) Appl. No.: 13/272,624

(22) Filed: Oct. 13, 2011

Related U.S. Application Data
(63) Continuation-in-part of application No. 13/034,528, filed on Feb. 24, 2011.
(60) Provisional application No. 61/307,784, filed on Feb. 24, 2010.

(51) Int. Cl. G06Q 30/02

(52) U.S. Cl. 705/7.32

(57) ABSTRACT

A reply of a survey responder is evaluated. A verbal response to a survey is received and a corresponding audio file is encoded. One or more evaluators are given access to both the audio file and a questionnaire including a question regarding a disposition of a survey responder. The evaluators select from a plurality of predefined answers to the question. A report is created based on the selected answers of the evaluators.

### CROSS-REFERENCE TO RELATED APPLICATIONS

This application is a continuation-in-part of and claims priority to, and the benefit of, U.S. application Ser. No. 13/034,528, filed on Feb. 24, 2011, titled “Methods And Apparatus For Employment Qualification Assessment,” which claims priority to, and the benefit of, to U.S. Application Ser. No. 61/307,784, filed on Feb. 24, 2010, titled “Methods And Apparatus For Employment Qualification Assessment,” the entire contents of each of which is incorporated herein by reference.

### FIELD

Embodiments generally relate to apparatuses, methods, devices, and systems to evaluate a candidate or candidate response (e.g., voice response), and more particularly, to apparatuses, methods, devices, and systems that autonomically evaluate one or more candidates or candidate responses for a market research, customer surveys, sales calls, scheduling calls, replenish calls, and/or occupational activities.

### BACKGROUND

The traditional process of calling and interviewing or surveying people in large volume or recruiting candidates can be time-consuming and inefficient. Thus, a need exists for an apparatus and method to collect and/or analyze information about, for example, a candidate for a particular occupation, or customer satisfaction after a purchase or the customer receiving a service, or employee satisfaction on continual basis, or citizen's opinion about policies, and so forth.

### SUMMARY

A computer program product, a method, and an article of manufacture to evaluate a response of a survey responder is presented. In certain embodiments, a verbal response to a survey is received and encoded in an audio file. One or more evaluators are given access to the audio file and a questionnaire. The questionnaire includes a question regarding a disposition of the survey responder in combination with a plurality of predefined answers to the question. An answer of the one or more evaluators is received and a report is created based on the received answer.

### BRIEF DESCRIPTION OF THE DRAWINGS

The invention will be better understood from a reading of the following detailed description taken in conjunction with the drawings in which like reference designators are used to designate like elements, and in which:

FIG. 1 illustrates Applicants' qualification processing system that includes a qualification processing module and a database, according to an embodiment;

FIG. 2 summarizes methods and/or processes related to information collection, according to an embodiment;

FIG. 3 summarizes a method for collecting information, according to an embodiment;

FIG. 4 illustrates analysis performed by Applicants' qualification processing system;

FIG. 5 illustrates client display and evaluation;

FIG. 6 summarizes Applicants' candidate-driven process;

FIG. 7 summarizes Applicants' client-driven process, according to an embodiment;

FIG. 8 illustrates at least a portion of the database shown in FIG. 1;

FIG. 9 illustrates processing of candidate information and/or client information;

FIG. 10 summarizes certain steps of Applicants' method for selecting one or more candidates for an occupational activity;

FIG. 11 summarizes certain steps of another Applicants' method for selecting one or more candidates for an occupational activity;

FIG. 12 summarizes additional steps of Applicants' method in for selecting one or more candidates for an occupational activity;

FIG. 13 illustrates Applicants' survey analysis system that includes a plurality of computing devices;

FIG. 14 summarizes steps of an exemplary method for analyzing responses to a survey; and

FIG. 15-18 illustrates exemplary screen shots rendered on a computing device of a client.

### DETAILED DESCRIPTION

Embodiments are described in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment. It is noted that, as used in this description, the singular forms “a,” “an” and “the” include plural referents unless the context clearly dictates otherwise. Thus, for example, the term “a query” is intended to mean a single query or a combination of queries.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

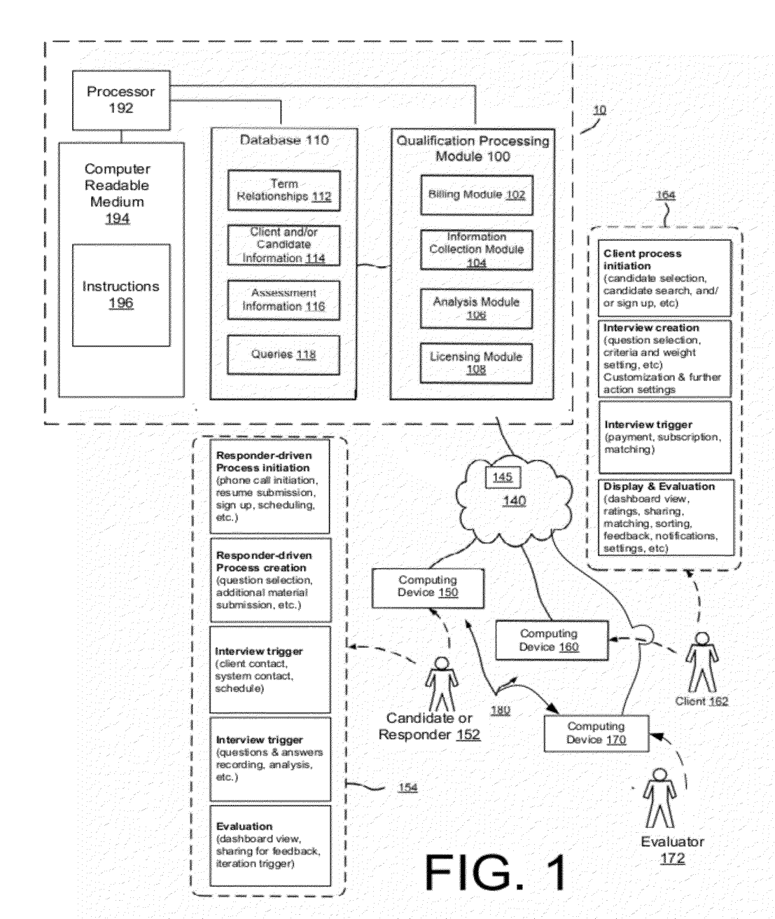

Many of the functional units described in this specification have been labeled as modules (e.g., module 100, FIG. 1) in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically collocated, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

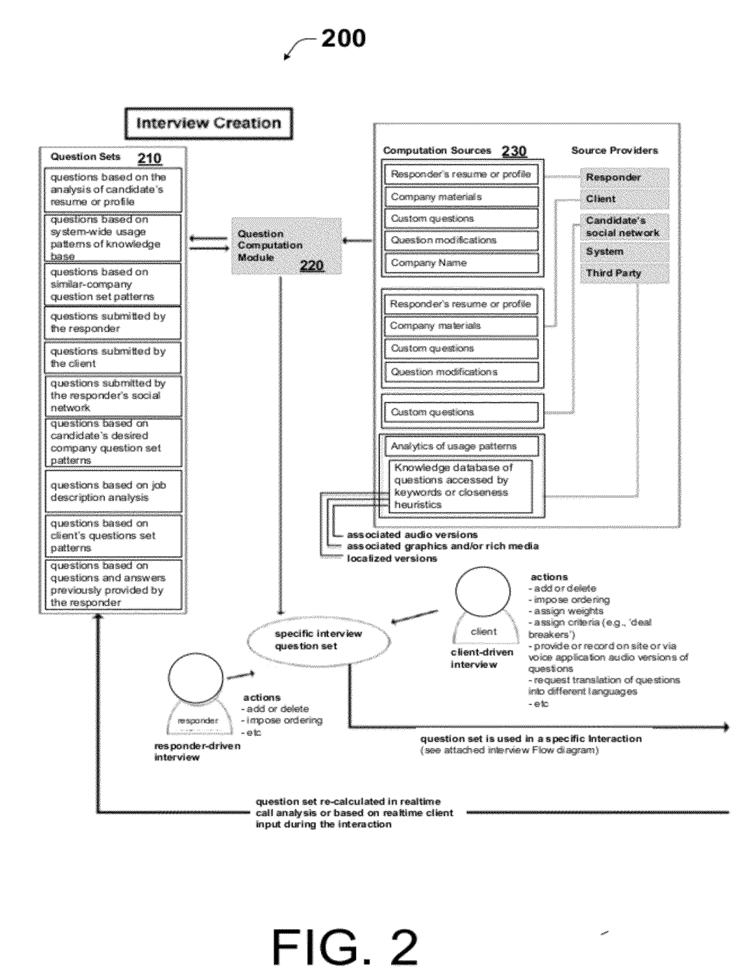

The schematic flow chart diagrams included are generally set forth as a logical flow-chart diagram (e.g., FIGS. 2-7, 9-12, and 14). As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method (e.g., FIGS. 2-7, 9-12, and 14). Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

A qualification processing system can be configured to automatically, autonomically, and/or dynamically facilitate processing of responder information (e.g., survey responses, or resume . . . etc.) of a responder for an activity (e.g., a market research; customer surveys; sales calls; scheduling calls; replenish calls; or an “occupational activity” such as a profession, a service, employment, a task, or a job, for example) and/or client information of a client requesting assistance with the activity.

In some embodiments, the responder information can be provided by a responder via a computing device in response to one or more queries (also can be referred to as questions). For example, the responder information can include a response (e.g., a textual response, a spoken and recorded response) to an interview question during one or more information collection sessions about, for example, the career aspirations of the candidate or consumer intentions toward a product or customer sentiments about a service, or a market survey analysis. The responder information can be stored in one or more databases in a variety of media formats (e.g., a textual format, a visual format, an audio format, a video format) so that the responder information can be, for example, accessed at a later time. Similarly, client information can be provided to the qualification processing system by a client via a computing device. In some embodiments, the candidate information and/or the client information can be analyzed to define, for example, rating information (of the client and/or the candidate) that can be used by a candidate and/or a client.

In some embodiments, a method is presented to enable the client to provide supporting background material and configure methods for selecting and evaluating responders. The responder is queried with an interaction that is based on at least the client's configuration and algorithmic determination of the appropriate querying given client's background material, responder's background material, and responder's previous responses. The responses to the interaction with the responder are collected, recorded, and analyzed. Based on the responses, the responder may be automatically selected for further query, automatic determination, or a set of pre-defined transactions. At least one of the client and the candidate are notified via automatic/autonomic transmission as to results of the interaction.

In some embodiments, candidate information and/or client information can be automatically and/or dynamically collected in response to one or more queries during an information collection session (e.g., an interview session). Queries for soliciting candidate information and/or client information can be defined by a candidate and/or a client (in a customized fashion) via a computing device so that the client can identify a desirable candidate for performing one or more activities and/or so that the candidate can identify an activity desirable to the candidate. In some embodiments, the queries can be defined by the responder and/or the client based on, for example, one or more parameters associated with (e.g., defining) the activity. In some embodiments, the client can be referred to as a requestor and can be, for example, a corporation, a manufacturer, an employer, a manager, an administrator, and/or so forth, and the responder can be referred to as a candidate, an applicant, a job-seeker, a customer, an employee, a professional, a resident, survey respondent, a customer, a consumer, a poll participant, and/or so forth. Therefore, in some embodiments, responder is synonymous with candidate and responder information is synonymous with candidate information. In other embodiments, responder has a different meaning than candidate and, in turn, responder device and responder information also have a different meaning than candidate device and candidate information, respectively.

In some embodiments, the qualification processing system can be configured to process a relatively large amount of responder information and/or client information automatically and/or dynamically so that responses, skills, adaptability, fit, sentiment, interest, and/or so forth of a responder and/or a client can be assessed in an efficient manner. In sum, the qualification processing system can be an interactive system configured to dynamically collect and/or analyze information associated with a client and/or a responder via an automated system (e.g., an automated voice-based system) and methods.

FIG. 1 is a schematic diagram that illustrates a qualification processing system 10 that includes a qualification processing module 100 and a database 110, according to an embodiment. As shown in FIG. 1, the qualification processing system 10 can be accessed by a responder 152, an evaluator 172, and/or a client 162 via a communication fabric 140. Although one processing module 100, one database 110, one responder 152, one evaluator 172, and one client 162 are shown in FIG. 1, it will be apparent that any number of modules, databases, candidates and clients can be part of the system in FIG. 1, and further that, while one communication fabric 140 is shown, any number of communication fabrics 140 could also be provided in the system of FIG. 1.

Specifically, the responder 152 accesses the qualification processing system 10 via the communication fabric 140 using computing device 150. In some embodiments, the computing device 150 is referred to herein as a responder computing device. Similarly, the client 162 accesses the qualification processing system 10 via the communication fabric 140 using computing device 160. In some embodiments, the computing device 160 is referred to herein as a client computing device. The evaluator 172 accesses the qualification processing system 10 via the communication fabric 140 using computing device 170. In some embodiments, the computing device 170 is referred to herein as a evaluator computing device 170.

In some embodiments, the qualification processing module 100 improves efficiency (e.g., turnaround time) and/or the impartiality of evaluation of data (e.g., client information and/or responder information) related to employment qualification assessment, consumer interest in the product, or customer satisfaction. Employment qualification assessment can include, for example, matching candidates with potential employers. Consumer interest assessment can include, for example, placing a consumer into the client sales leads queue.

The communication fabric 140 comprises one or more switches 145. In certain embodiments, communication fabric 140 comprises the Internet, an intranet, an extranet, a storage area network (SAN), a wide area network (WAN), a local area network (LAN), a virtual private network, a satellite communications network implemented as a wired and/or wireless network with one or more segments in a variety of environments such as, for example, an office complex. The communication fabric 140 may contain either or both wired or wireless connections for the transmission of signals including electrical connections, magnetic connections, or a combination thereof. Examples of these types of connections are known in the art and include: radio frequency connections, optical connections, telephone links, a Digital Subscriber Line, or a cable link. Moreover, networks may utilize any of a variety of communication protocols, such as Transmission Control Protocol/Internet Protocol (TCP/IP), for example.

In some embodiments, the qualification processing system 10 can be directly accessed (not via a network) by the responder 152 and/or the client 162 via, for example, a user interface that may or may not include a visual display device. In some embodiments, the client 162 and/or the responder 152 can access the qualification processing system 10 via the same computing device.

The computing device 150, the computing device 160, and the computing device 170 can be collectively referred to as computing devices 180. In some embodiments, the computing device(s) 180 may each be an article of manufacture such as a server, a mainframe computer, a mobile telephone, a personal digital assistant, a personal computer, a laptop, an email enabled device, a web enabled device having one or more processors (e.g., a Central Processing Unit, a Graphical Processing Unit, or a microprocessor), and/or so forth, that is configured to execute an algorithm (e.g., a computer readable program code or software) to receive data, transmit data, store data, or performing methods or other special purpose computer.

In certain embodiments, each computing device 180 comprises a non-transitory computer readable medium readable medium having a series of instructions, such as computer readable program code, encoded therein. In certain embodiments, the non-transitory computer readable medium comprises one or more data repositories. The computing device(s) 180 may include wired and wireless communication devices which can employ various communication protocols including near field (e.g., “Blue Tooth”) and far field communication capabilities (e.g., satellite communication or communication to cell sites of a cellular network) that support any number of services such as: Short Message Service (SMS) for text messaging, Multimedia Messaging Service (MMS) for transfer of photographs and videos, or electronic mail (email) access.

By way of example, the computing device(s) 180 may be as a server, including a processor, a non-transitory computer readable medium, an input/output means (e.g., a keyboard, a mouse, a stylus and touch screen, or a printer) or, and a data repository. The processor accesses executable code stored on the non-transitory computer readable medium of the computing device(s) 180, and executes one or more instructions to, for example, electronically communicate via the communication fabric 140.

In some embodiments, the database 110 can be a consolidated and/or distributed database. In some embodiments, the database 110 can be implemented as a database that is local to the qualification processing module 100 and/or can be implemented as a database that is remote to the qualification processing module 100. In some embodiments, the database 110 can be encoded in a memory included in the qualification processing module 100 and/or included in a system that includes the qualification processing module 100. The database 110 may be encoded in one or more hard disk drives, tape cartridge libraries, optical disks, or any suitable volatile or nonvolatile storage medium, storing one or more databases, or the components thereof, or as an array such as a Direct Access Storage Device (DASD), redundant array of independent disks (RAID), virtualization device, . . . etc. The database 110 may be structured by a database model, such as a relational model or a hierarchical model.

In some embodiments, one or more portions of the qualification processing system 10 can be implemented as a web-based software application. Although not shown, in some embodiments, at least one or more portions of the qualification processing system 10 can be implemented as a software and/or hardware module that can be locally executed on one or more of the computing devices 180. In such instances, other functionality of the qualification processing system 10 can be accessed via the communication fabric 140. For example, a software application locally installed at the computing device 150 can be used to access at least a portion of the qualification processing system 10.

In some embodiments, a web-based interface locally executed and/or displayed at the computing device 150 can be used to access at least a portion of the qualification processing system 10. Accordingly, the client 162 (e.g., a hiring manager, a human resource professional, a contractor, a marketing personnel) who may be interested in, for example, accessing (for evaluation purposes or statistical analysis of marketing surveys) information about one or more candidates (such as responder 152) for a particular activity (e.g., political polling analysis, a certain job opening such as an accountant position or an account manager position, or sales calls for a particular product or service, or determination of voter intent for setting policies) can access the functionality of the qualification processing system 10 via the web-based interface. In some embodiments, the qualification processing system 10 can be configured so that the client 162, for example, may be able to place a questionnaire, or job requirement, for example, and a pre-defined set of phone interview questions through a desktop or a mobile application and/or through the use of phone or website. In some embodiments, the qualification processing system 10 can be configured so that the client may be able to define a set of text and phone interview questions, and a set of criteria for flagging follow-up for customer service.

Similarly, the responder 152 who may be interested in accessing (e.g., for job search purposes) information about a particular activity can access the functionality of the qualification processing system 10. In other words, one or more portions of the qualification processing system 10 can be triggered through, for example, a dedicated website, embedded code and/or so forth. The embedded code can be configured to identify an electronic display or a resume, an electronic communication (e.g., an email, a text message, a voice message), and/or so forth.

As shown in FIG. 1, the qualification processing module 100 includes a billing module 102, an information collection module 104, an analysis module 106, and a licensing module 108. As shown in FIG. 1, the database 110 is configured to store term relationships 112, client and/or responder information 114, assessment information 116, and queries 118. The licensing module 108 manages licenses associated with, for example, software and/or communication media.

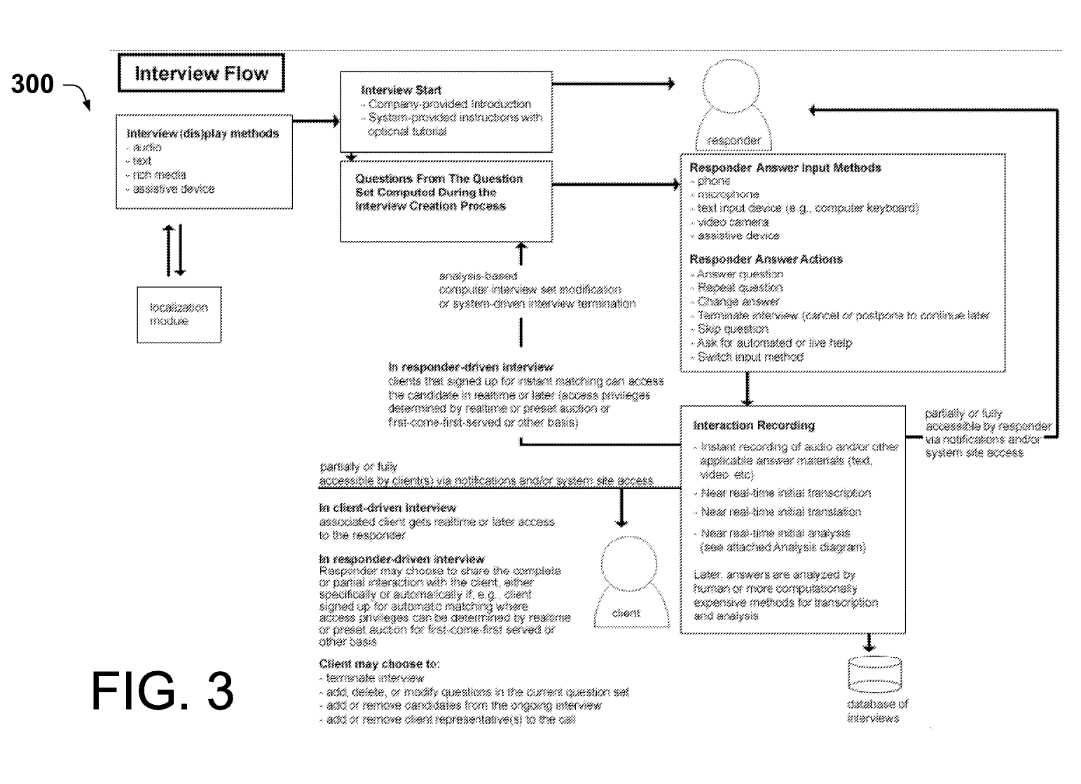

In some embodiments, the information collection module 104 communicates with the client 162 and/or the responder 152 to collect information about the client 162 and/or the responder 152 that can be used to, for example, assess the qualifications of the responder 152, the responses of the responder 152, and/or assess an aspect of the client 162. In some embodiments, for example, the responder information is collected via an interactive interview process. In some embodiments, the information collection module 104 collects information from references (via automatic reference calls). In some embodiments, the responder, the client, and/or the qualification processing system 10 can trigger an invitation for a individual identified as a reference to call in/call out and provide, for example, a written and/or audio reference for the responder 152 and/or the client 162. In some embodiments, one or more portions of the interview process can be defined by the client 162 as shown in the client-triggered functions 164. More details related to collection of information, for example, using an interview are shown in FIG. 2 and FIG. 3.

FIG. 2 Summarizes Applicant's methods and/or processes related to information collection, according to an embodiment. The information that is collected can be candidate information and/or client information. As shown in FIG. 2, question sets 210 (also can be referred to as query sets) used to solicit information can be processed by a client and/or a responder (via a computing device such as those shown in FIG. 1) using the question computation module 220 (also can be referred to as a query computation module). In some embodiments, the question computation module 220 is integral with the information collection module 104 shown in FIG. 1. The question computation module 220 can be configured to present one or more questions to a responder and/or a client (via a computing device in FIG. 1) as shown in FIG. 2. In some embodiments, the questions computation module 220 uses information from one or more computation sources 230.

In some embodiments, the question computation module 220 computes questions for one or more responders based on the analysis of one or more requirements of the activity (e.g., job requirements) and/or information about the responder such as a candidate's resume. In some embodiments, the question computation module 220 selects one or more queries (e.g., from a library of queries) based on the pattern of usage by one or more users (e.g., one or more clients, one or more responders) of the system. In some embodiments, the question computation module 220 dynamically adapts during a querying session such as an interview to responses by one or more responders.

FIG. 3 summarizes Applicant's method for collecting information, according to an embodiment. As shown in FIG. 3, the information can be collected during an interview. As shown in FIG. 3, the responder and/or the client (via computing device such as those shown in FIG. 1) is interactively involved in the information collection process. In some embodiments, the information collection can be performed via a portion of the information collection module 104 shown in FIG. 1 (e.g., the question computation module 220 shown in FIG. 2). In some embodiments, the information collected via the method disclosed in FIG. 3 is stored in an interview database. In some embodiments, the interview database is associated with the database 110 shown in FIG. 1.

In some embodiments, at least a portion of the information collection module 104 (e.g., the questions computation module 220 of the information collection module 104) autonomically revises, adds and/or subtracts any computed question/query, rank the order of the questions/queries, and/or weighs the questions/queries. These functions are performed based on one or more rules-based algorithms that can be customizable (by the client 162 and/or the responder 152). In some embodiments, at least a portion of the information collection module 104 (e.g., the questions computation module 220 of the information collection module 104) are configured so that the client 162 and/or the responder 152 may (via a computing device) revise, add and/or subtract any computed question/query, and/or rank the order of the questions/queries.

In some embodiments, the information collection module 104 (or a portion thereof) terminates an information collection session, such as for example, an interview based on real-time analysis of responses from, for example, the responder 152 and/or the client 162. In some embodiments, the information collection module 104 (or a portion thereof) modifies one or more queries (or a portion of an interview) and/or provide a different question(s) based on real-time analysis of the responses from, for example, the responder 152 and/or the client 162.

In some embodiments, the information collection module 104 (or a portion thereof) sends a notification (e.g., an indicator, a message), for example, to one or more individuals (e.g., a client) during a course of an information collection process such as an interview. For example, the information collection module 104 sends a notification that one or more persons (e.g., the client 162) should immediately intervene and/or take part in an interview with the responder 152. In some embodiments, the information collection module 104 sends a notification that one or more persons should add or subtract responders during the course of an interview with another responder, show written and/or visual questions, and/or initiate a test (e.g., a quiz) via a networked (e.g., an online) display and/or communications medium (e.g., a chat). In some embodiments, the notification can be sent via a notification module (not shown) associated with the information collection module 104. In some embodiments, the information collection module 104 communicates with the responder 152 and/or the client 162 to automatically schedule a follow-up information collection session (e.g., a follow-up interview), if necessary (as determined based on one or more rules-based algorithms). In some embodiments, the information collection module automatically makes a determination or initiates a transaction (e.g., schedules a sales visit, transfers the call to customer support, emails a coupon).

As shown in FIG. 1, the qualification processing module 100 of the qualification processing system 10 includes a billing module 102. In some embodiments, the billing module 102 processes billing and/or payments related to use of the qualification processing system 10. In some embodiments, the billing module 102 automatically processes billing and/or payments through the use of credit card, phone bill, online or offline payment systems, by linking a bank account to the system, and/or so forth. In some embodiments, the billing module 102 bills and/or collects payment from the client 162 and/or the responder 152 based on, for example, a number of interviews conducted, a number of successful interviews (as measured by a client's acceptance to trigger a follow-up action with any responder), a subscription basis, selection of the responder 152 to perform an activity, and/or so forth. The information used by the billing module 102 can be stored in the database 110.

In some embodiments, the information collection module 104 communicates with one or more responders (such as responder 152) and/or one or more clients (such as client 162). For example, the information collection module 104 automatically contacts one or more active and/or passive candidates, automatically solicits their permission to be contacted (and/or interviewed), automatically schedules an interview (and/or follow-up) with a candidate, automatically provides information (e.g., a phone number) related to an interview, automatically permits a candidate to activate an outbound call to a candidate's phone number (and/or computer), and/or allows a candidate to identify themselves by entering a dedicated personal identification number. In some embodiments, contact with a responder is automatically initiated after the responder has been automatically selected by the qualification processing system 10 (e.g., information collection module 104 of the qualification processing module 100) via a pre-screening process. The pre-screening process can be performed based on one or more rules-based algorithms including preferences defined by, for example, a client based on one or more parameters related to an activity (e.g., a job). In some embodiments, the functions described above are performed by, for example, a communication module (not shown) of the information collection module 104.

In some embodiments, an instruction module (not shown) of the qualification processing module 100) executes one or more tutorial and/or instruction sessions. The tutorial and/or instruction session can be related to any portion of the qualification processing system 10 and can be triggered to execute at a computing device of the responder 152 and/or the client 162.

In some embodiments, the qualification processing system 10 authorizes the responder 152 and/or the client 162 to control an information collection session (e.g., a question flow associated with an interview). For example, the qualification processing system 10 repeats a question, receives a response to a question, plays back a response to a question, changes a response to a question, moves on to another question, and/or asks for live help, response to an instruction from the responder 152 and/or the client 162 (via a computing device).

In some embodiments, the qualification processing system 10 records responses from the responder 152 and/or the client 162 in real-time by way of automatic application and/or through the use of human transcription service. In some embodiments, the qualification processing system 10 analyzes the response and/or computes a score (e.g., a rank) that represents, for example, the candidate's fit to a specific activity (or a general activity), and/or a general attribute.

In some embodiments, the qualification processing system 10 computes a relevancy rank based on information collected by the qualification processing system 10 such as an interview transcript, a score on a survey, a resume, a job description, demographic information, client-set criteria, any other combination of responder and/or client information. In some embodiments, the qualification processing system 10 performs a computation process enabling a relevancy rating and/or sorting of candidates (such as responder 152) for each activity before, for example, any human-to-human interaction.

In some embodiments, the qualification processing system 10 provides an assessment of a responder's and/or a client's sentiment based on computing information related to the responder and/or the client. In some embodiments, the qualification processing system 10 assesses and/or displays a responder's and/or a client's sentiment towards, for example, a question or toward the context of the question. In some embodiments, the sentiment can be a positive sentiment, a negative sentiment, an ambivalent sentiment, interest sentiment, a mood sentiment (e.g., happiness, sadness, anger, ease, frustration, and/or motivation).

In some embodiments, the qualification processing system 10 provides an assessment of a responder's disposition towards a political issue, disposition toward a product or manufacturer, an education level, a quality of communication skills, sincerity, enthusiasm, behavior under pressure, and/or a psychological profile. In some embodiments, the assessment can be based on responses to specific questions targeting an aspect of the responder, textual structure of the responder's responses, and/or audible tonality of the responder's responses. In some embodiments, the qualification processing system 10 uses the semantic similarity between the client's provided materials and responder's answers to calculate a culture fit between the two parties. In some embodiments, the analysis can be based on relationships (e.g., semantic relationships) such as term relationships 112 stored in the database 110.

In some embodiments, the qualification processing system 10 determines a responder's and/or a client's adaptability and skills based on input provided by the assessor. In some embodiments, the qualification processing system 10 via text, spoken message, and/or visual aids, allows a responder to provide feedback to one or more portions of responder information (such as a recorded interview) and/or client information recorded where the system has rated one or more responders and/or clients.

In some embodiments, the qualification processing system 10 electronically distributes responder information, analysis, and/or so forth to a responder and/or a client. In some embodiments, the qualification processing system 10 enables a responder and/or a client to, for example, replay part or the entirety of an interview, review the rankings, sort responders by pre-set criteria, share the result in order to view, listen, and/or poll the ranking with other people, and make determinations In some embodiments, the qualification processing system 10 enables a responder and/or a client to comment, and/or initiate a follow-up action (e.g., an automated interview) with some or all of the responder and/or clients.

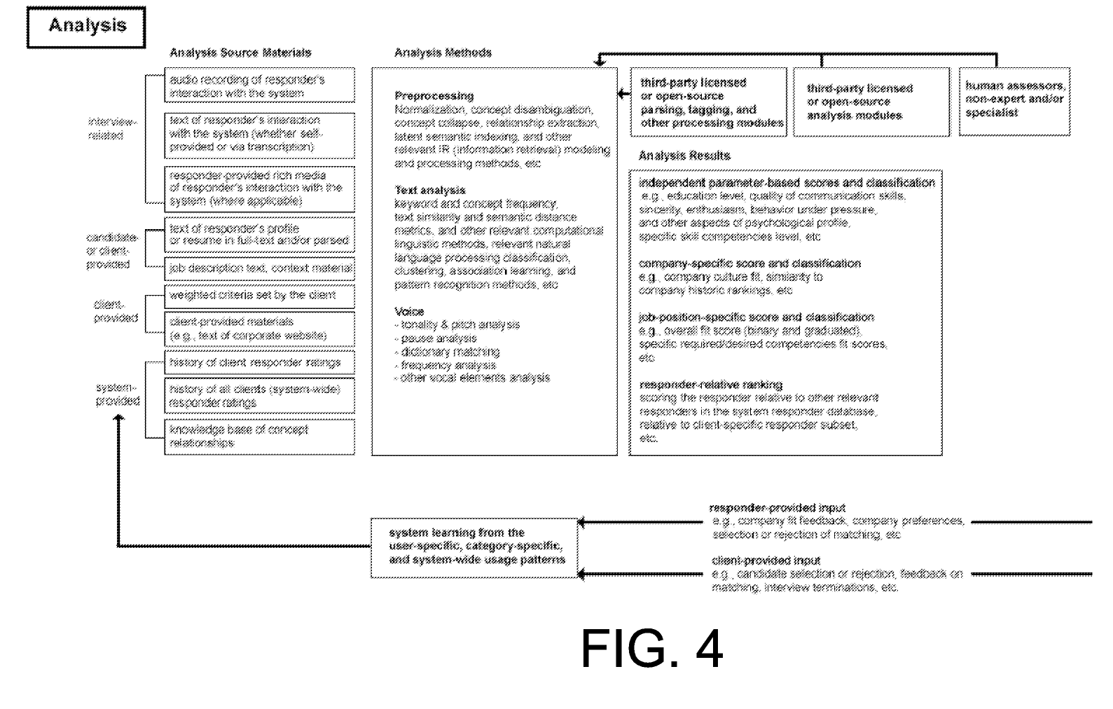

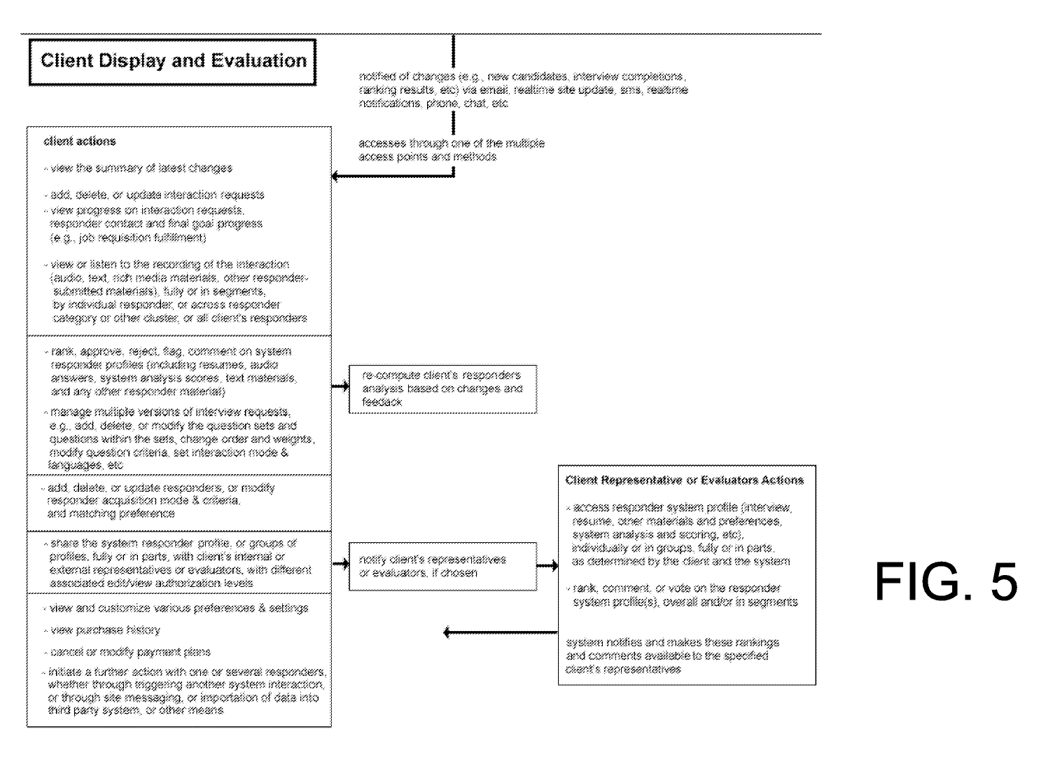

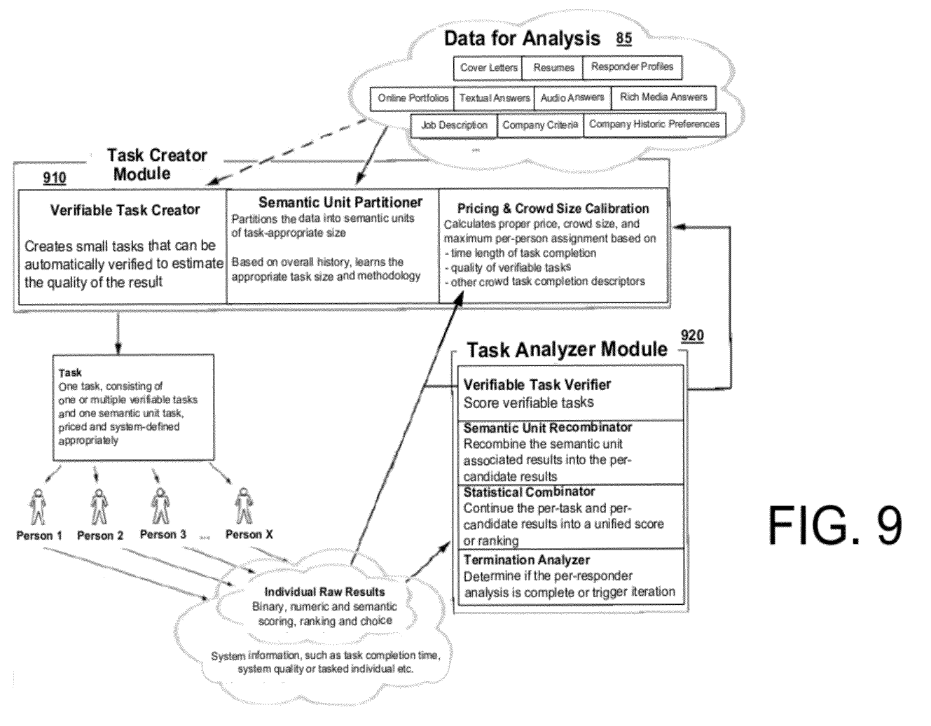

In some embodiments, the qualification processing system 10 collects feedback. In some embodiments, the feedback can either signal agreement or disagreement of the assessor with the system's initial assessment regarding the rating, adaptability, response, and/or skills of one or more responders and/or clients. In some embodiments, the qualification processing system 10 re-computes, in response to feedback, one or more portions of responder information and/or client information to reflect a new rating and/or assessment based on feedback. In some embodiments, the qualification processing system 10 improves automatic rating and assessing capabilities based on feedback provided by a responder and/or a client. In some embodiments, the qualification processing system 10 applies its learning to one or more assessments and/or specific sections of it based on a rules-based algorithm (as defined by a responder and/or a client). More details related to analysis of client and/or responder information is shown in FIG. 4 and FIG. 9, and more details related to feedback are shown in connection with FIG. 5.

In some embodiments, the qualification processing system 10 serves passive or active job seekers by allowing them to perform, for example, an information collection session such as a phone interview.

In some embodiments, the information collection session can include entering of information by the client 162 and/or the responder 152. In some embodiments, the qualification processing system 10 automatically and/or autonomically chooses parameters that will allow the qualification processing system 10 to compute questions that match a candidate's career aspirations. In some embodiments, the qualification processing system 10 enables a responder to self-evaluate an interview and/or share the interview with friends or with a selective group of professionals for free or for a fee, or broadcast to potential interested parties (e.g., employers). In some embodiments, the qualification processing system 10 collects the information provided by a responder and/or a client, collects reviews and comments made by other individuals, and/or computes a ranking for the responder and/or the client.

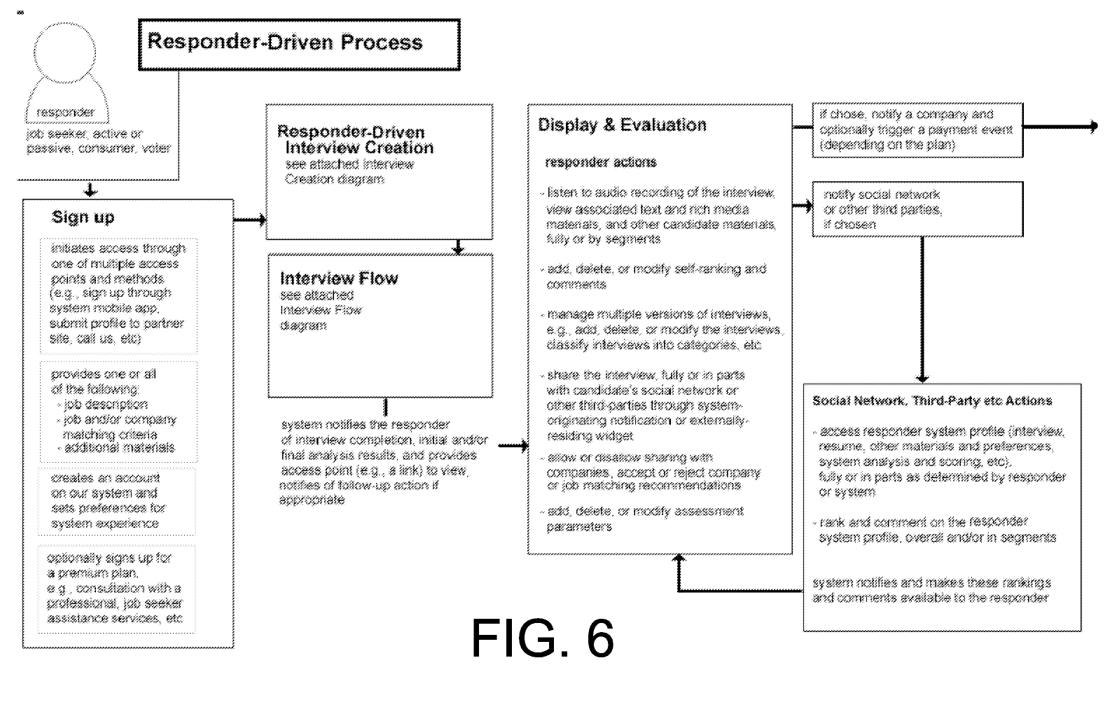

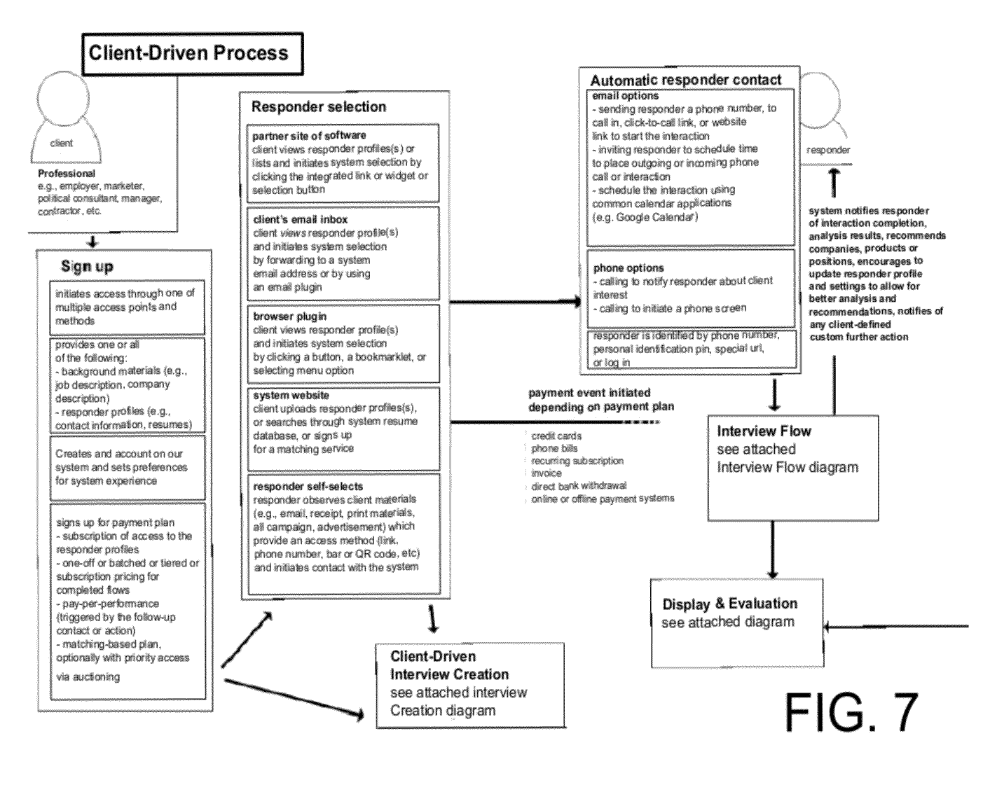

In some embodiments, the qualification processing system 10 can be configured to operate based on a client-driven process and/or based on a responder-driven process. More details related to a responder-driven process are shown in FIG. 6, and more details related to a client-driven process are shown in FIG. 7.

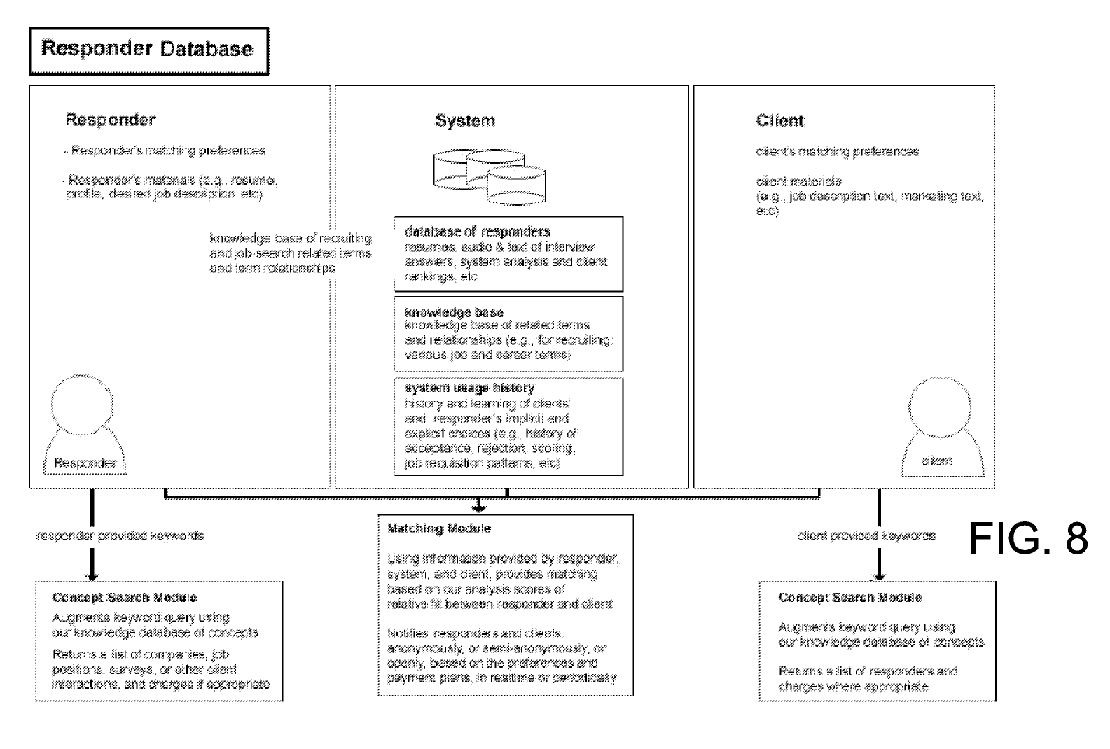

In some embodiments, one or more portions of the database 110 can be searched using keyword, concept, and/or proximity matching. In some embodiments, the database 110 can be searched based on voice input taken from an information collection session such as a responder's (or client's) interview (or interviews), resume, and/or other information that the system gathered and computed. In some embodiments, the client can for example, replay a pre-recorded phone interview, and then follow up with additional interviews with the responder. In some embodiments, the database can be continuously updated with ratings of one or clients and/or responders based on information collection sessions (such as phone interviews). FIG. 8 is a schematic diagram that illustrates at least a portion of the database 110 shown in FIG. 1.

In some embodiments, the qualification processing system 10 functions using one or more different languages. For example, one or more portions of the qualification processing system 10 are translated into and/or deployed in any language or multi-language processes so that, for example, one or more portions of an information collection process (via an interactive interview) can be performed in one or more languages.

In some embodiments, the qualification processing system 10 is configured so that only those authorized to access the qualification processing system 10 may do so. In some embodiments, the qualification processing system 10 is configured so that the responder 152 and/or the client 162 must prove that they are authorized (via a login process) to access the qualification processing system 10. In some embodiments, the credentials of the responder 152 and/or the client 162 must be authenticated before the responder 152 and/or the client 162 may access the qualification processing system 10.

FIG. 9 is a schematic diagram summarizing Applicant's method to process responder information and/or client information. As shown in FIG. 9, the candidate information and/or the client information is collectively referred to as data for analysis 85. As shown in FIG. 9, the data for analysis 85 is processed at a task creator module 910 so that the data for analysis 85 can be evaluated, and an evaluation of the data for analysis 85 (which can be represented by raw results) is processed at the task analyzer module 920 (and/or the task creator module 910). In some embodiments, the processing performed by the task creator module 910 and/or the task analyzer module 920 can be referred to crowd-sourcing evaluation. Specifically, the task creator module 910 and the task analyzer module 920 can trigger evaluation of candidate response relevancy (e.g., absolute and/or relative) to a specific and/or a generic type of activity based on data collected from multiple candidates. The evaluation can be triggered based on one or more tasks assigned to one or more evaluators by the task creator module 910. In some embodiments, a task can include a verifiable task, a semantic unit, task parameter value (which can represent a characteristics, such as an assignment characteristic, of a task), and/or so forth.

As shown in FIG. 9, the task creator module 910 distributes (e.g., send, transmit) one or more portions of the data for analysis 85 to one or more persons “evaluators” (e.g., one or more computing devices associated with one or more persons) for evaluation. In some embodiments, the portion(s) can be distributed to more than one person (e.g., 5 people, 50 people, 1000 people) via respective devices (e.g., computing device of the evaluator). The evaluation can be triggered by one or more tasks and can be represented by raw results shown in FIG. 9 (also can be referred to as individual raw results). In some embodiments, the person(s) can be referred to as evaluators. The evaluations conducted by the evaluators (to produce the raw results) can be processed at the task creator module 910 and/or at the task analyzer module 920.

As shown in FIG. 9, the task creator module 910 optionally comprises a Verifiable Task Creator module, a Sematic Unit Partitioner module, and/or a Pricing and Crowd Size Calibration Module. In some embodiments, the Verifiable Task Creator module analyzes client information (e.g., job requirement information, or sales materials) and/or responder information to create one or several verifiable tasks. The tasks can be related to information that can be used to judge the quality of the overall task result. For example, the tasks can be related to determining the number of required skills, determining whether or not a college degree is required, and/or determining a day of the week.

In some embodiments, the Semantic Unit Partitioner divides client information (e.g., job requirement information or explicitly set criteria) and/or responder information into units for gathering and scoring. In some embodiments, the Sematic Unit Partitioner module divide the information based on a particular criteria (e.g., a maximum) related to efficiency for gathering and scoring the results. In some embodiments, such units can be “candidate resume and job description”, “candidate years of experience and company required years of experience”, and/or “a first candidate profile, a second candidate profile, and activity description.”

In some embodiments, various characteristics related to tasks are defined. The characteristics of the tasks can be referred to as task parameter values. In some embodiments, task characteristics can be defined by the Pricing & Crowd Size Calibration module based on the previous results (e.g., previous raw results, previous statistics defined by the qualification processing module). In some embodiments, a task parameter value comprises, for example, a price, a number of persons assigned to perform one or more tasks, a per-person task level (e.g., maximum level, minimum level), a time period (e.g., a maximum time period, a minimum time period) for completing a task, task quality ranking, and/or so forth.

In some embodiments, the raw results comprise, for example, a rank ordering of at least a portion of the data for analysis 85 and/or a comparison of at least a portion of the data for analysis 85. For example, the evaluators can be presented (by the task creator module 910) with several portions of the data for analysis 85 within a task, and one or more portions of the raw results comprise a rank ordering of the portions of the data for analysis 85. In some embodiments, the rank ordering can be defined based on a comparison of one or more portions of data for analysis 85 (as prompted via a task). In some embodiments, one or more portions of the raw results comprise a written evaluation (or based on a written evaluation) defined by one or more of the evaluators (as prompted via a task). In some embodiments, one or more portions of the raw results can be (or can include) keywords that are associated with a portion of the data for analysis 85 by one or more of the evaluators.

In certain embodiments, Applicant's method will prompt binary decisions (“is the candidate response appropriate or not?”, “does candidate have skill X?”, “does this person sound angry?”, “did the consumer express interest in the product?”), multiple choice (“the candidate is well-qualified or somewhat qualified or not qualified”), rankings (“rank these several candidates based on their competency in skill X”), and/or descriptions (“describe top three strengths of the candidate”). In some embodiments, the Semantic Unit Partitioner module comprises machine learning capability that can be configured to analyze previous system results to guide future unit partitions.

In some embodiments, the task creator module 910 partitions and/or reformats one or more portions of the data for analysis 85 before distributing the data for analysis 85 to selected evaluator(s) for evaluation. For example, a portion of the data for analysis 85 can be subdivided and/or reformatted so that the portion can be evaluated by an evaluator in a desirable fashion. In some embodiments, the portion can be reformatted so that the portion can be presented to the evaluator within a particular type of graphical user interface and/or questions format. In some embodiments, data for analysis 85 can be distributed to the evaluators as tasks (or as overall tasks). In some embodiments, an overall task can be a task that one tasked person/evaluator can access in a single task instantiation.

In some embodiments, the evaluators can be non-expert evaluators (e.g., individuals not affiliated with or in the business of responder information and/or client information evaluation) registered (e.g., at the task creator module 910) as evaluators. In some embodiments, the evaluators and/or portion(s) of the data for analysis 85 can be randomly selected (e.g., selected by the task creator module 910) from a pool or set of evaluators, selected (for receipt of a portion of the data for analysis 85) based on a statistical calculation, and/or evaluator selection criterion. In some embodiments, the evaluators and/or portion(s) of the data for analysis 85 are selected (e.g., selected by the task creator module 910) based on an algorithm.

In some embodiments, the evaluators and/or portion(s) of the data for analysis 85 are selected (e.g., selected by the task creator module 910) based on a predefined order and/or a ranking. In some embodiments, one or more of the evaluators and/or portion(s) of the data for analysis 85 can be selected (e.g., selected by the task creator module 910) based on, for example, a user preference (associated with a client and/or a responder).

In some embodiments, one or more portions of the data for analysis 85 are, for example, iteratively analyzed, analyzed based on a feedback loop, analyzed based on a feed-forward loop, and/or so forth, through the module(s) and/or process(es) shown in FIG. 9. In some embodiments, one or more portions of the data for analysis 85 care processed (or re-processed) at the task creator module 910 and/or the task analyzer module 920 based on statistical information related to raw results. For example, a particular type of responder information and/or client information from the data for analysis 85 are re-distributed from the task creator module 910 to a set of evaluators (e.g., more than one evaluator, 50 evaluators) when raw results from an evaluation conducted by another set of evaluators satisfies (or does not satisfy) a particular statistical threshold value (e.g., a quality threshold value) and/or, for example, a threshold (e.g., a standard) defined by an expert evaluator.

In some embodiments, the task analyzer module 920 analyzes one or more portions of the raw results according to a preference of a client and/or a responder. In some embodiments, the task analyzer module 920 analyzes (e.g., statistically analyze, analyze based on an algorithm) one or more portions of the raw results. In some embodiments, one or more portions of the raw results are compared with one or more portions of historical raw results stored at, for example, the database 110 shown in FIG. 1.

As shown in FIG. 9, the task analyzer module 920 optionally comprises a Verifiable Task Verifier module, a Semantic Unit Recombinator module, a Statistical Combinator module, and/or a Termination Analyzer module. In some embodiments, a verifiable task associated with task can be scored at the Verifiable Task Verifier module. In some embodiments, this information, along with other task completion information, such as the average task completion time, system-determined quality of the tasked individuals, and other information is provided to the Pricing & Crowd Size Calibration for later use. In some embodiments, the Semantic Unit Recombinator module and/or the Statistical Combinator module analyzes the raw results to define a unified score or ranking for each responder information and/or client information (e.g., job requirement information or explicitly set criteria) set.

In some embodiments, the Termination Analyzer determines (based on a result from the Semantic Unit Recombinator module and/or the Statistical Combinator module) if the raw result satisfies a threshold condition (e.g., a system-set requirements (e.g., is the result statistically significant, have top X candidates for the job requirement been chosen, have the responders been sorted into three groups, etc)). In some embodiments, if the threshold condition is not satisfied, the Termination Analyzer can be configured to trigger another iteration of task creation by the task creator module 910 for one or more sets of responder information and/or client information (e.g., job requirement information). In some embodiments, data related to analysis at the task analyzer module 920 is stored and/or used to contribute to the future Semantic Partitioner decisions.

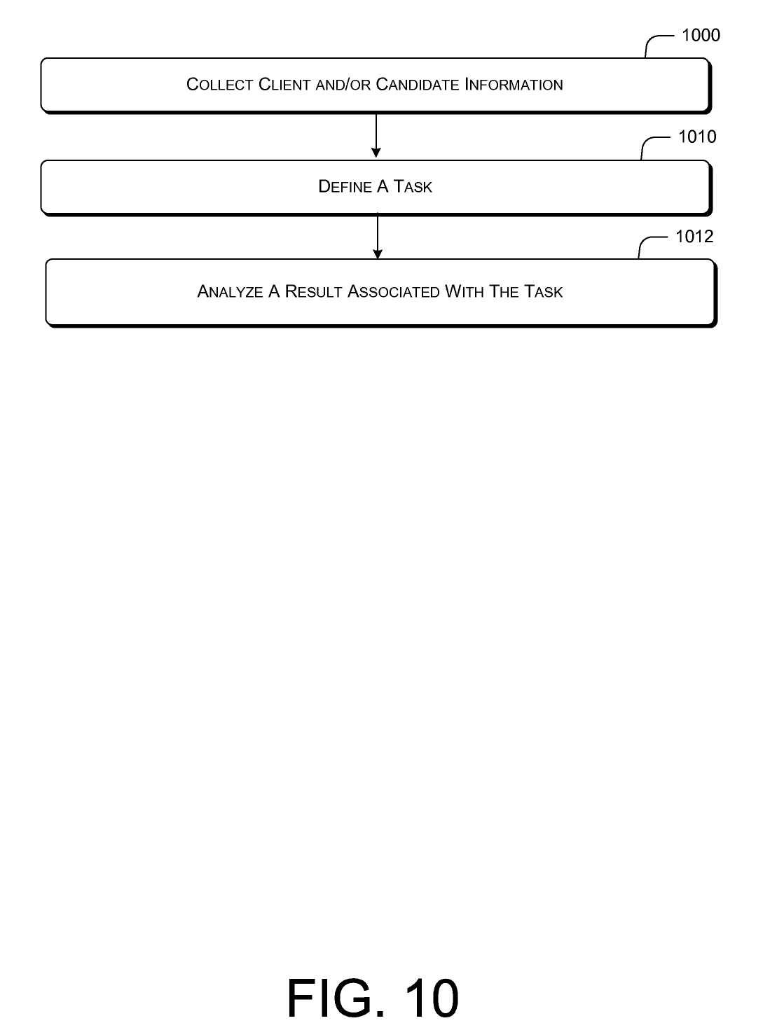

FIG. 10 is a schematic diagram that summarizes Applicant's method for processing at qualification processing module. Specifically, the method illustrates processing that can be performed at, for example, various modules of a qualification processing module such as that shown in FIG. 1. The various modules comprise an analysis module (such as analysis module 106 shown in FIG. 1), a task creator module (such as task creator module 910 shown in FIG. 9), a task analyzer module (such as task analyzer module 910 shown in FIG. 9).

As shown in FIG. 10, client and/or responder information is collected, at 1000. For example, job requirement information from an employer or recruiter, or generic job requirement information generated internally and not associated with any open position can be collected. In some embodiments, client information (e.g., company information) can be in the form of a job description (or a portion thereof), a weighted criteria, a set of questions, and/or other relevant material. In some embodiments, the client information can be collected via web, phone, and/or in-person. In some embodiments, the client information can be supplemented by the knowledge of the client's previous requirements and/or previous ratings of results. In some embodiments, the responder information can be collected concurrently or consecutively. In some embodiments, the candidate information can take the form of candidates applying for the job with resume submission, online portfolio, link to or form-submitted profile, phone or video interview, text-based testing, and/or so forth. In some embodiments, the responder information is provided by the client or through a third party.

A task is defined, at 1010. For example, in some embodiments, client information (e.g., job requirement information) and/or responder information can be used to define one or more tasks at, for example, a task creator module such as that shown in FIG. 9. In some embodiments, the task can be assigned to a group of individuals (i.e., evaluators), anonymous or not, expert or not, affiliated with the client or not, to evaluate (e.g., vote, rank, score, or describe) the client information and/or responder information presented to them.

As shown in FIG. 10, a result associated with the task is analyzed, at 1012. In some embodiments, the result can be, for example, a raw result. In some embodiments, the result can be analyzed by the Task Analyzer Module after a specified period of time (e.g., a maximum period of time) has passed (as defined within a task parameter value).

In some embodiments, one or more results (e.g., computed results) can be shared on (e.g., shared on an as-needed basis) with the client and/or responder. In some embodiments, the qualification processing module can be configured to trigger additional action, whether based on the responder's response, company response, or self-requirement, to gather additional data, such as follow-up interview, or test, or survey. This data can also be sent through the modules to compute an iterative result.

As an example, a job description for a sales position in a medium-size online publishing firm specializing in travel can be collected. That job requirement can be posted on one or more web sites, mobile devices, computers, print, etc. Several job applicants (e.g., candidates) can apply via resume submission, form fill, test and/or so forth. A set of non-experts (e.g., 50 non-expert evaluators) can be tasked so that each non-expert sees part or all of the job requirement and/or part or all of, for example, two or more candidates' information. The evaluators can then be prompted (via a task) to vote on which candidate data is in better agreement with the requirement. The results can be computed (and once statistical significance achieved) and the size of the number of applicants can be reduced to those who were statistically in better agreement with the requirement. The information associated with the candidates can be sent again for non-expert evaluation until the size of the candidate group matches a specified requirement (e.g., a system requirement, a client preference).

In some embodiments, follow-up action can be triggered with respect to the group of responders. In some embodiments, follow-up can be a phone interview. Once interviews are completed, another set of non-experts (e.g., 70 non-expert evaluators) can be tasked so that each non-expert sees part or all of the job requirement and listens to part or all of, for example, two or more candidates' phone interview recordings. This other set evaluators (which can overlap with the first set of evaluators) can then be prompted (via a task) to vote on which candidate data is in better agreement with the requirement. The results can be computed (and once statistical significance achieved) and the size of the number of applicants can be reduced to those who were statistically in better agreement with the requirement. In some embodiments, this process can be repeated until the size of the candidate group matches a specified requirement.

After the size of the group matches the specified requirement, billing, assessment and/or other functions can be performed by the qualification processing module. In some embodiments, other modules can be configured to provide an employer and/or a recruiter with information related to the narrowing of the original list of candidates to a group of likely hires.

In some embodiments, the task creator module 910 and/or the task analyzer module 920 can be a sub-module within the qualification processing module 100. In some embodiments, the task creator module 910 and/or the task analyzer module 920 is integral with the analysis module 106. In some embodiments, the database 110 shown in FIG. 1 can be used by the task creator module 910 and/or the task analyzer module 920 to perform processing related to the functions associated with these modules.

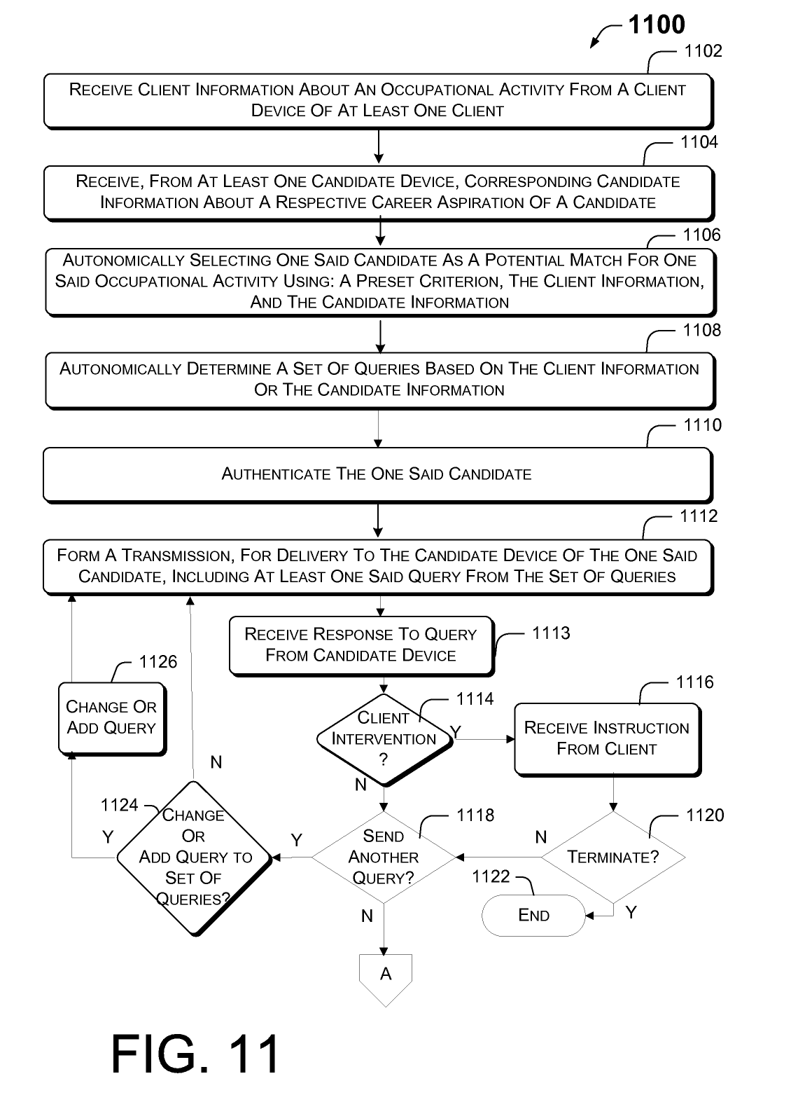

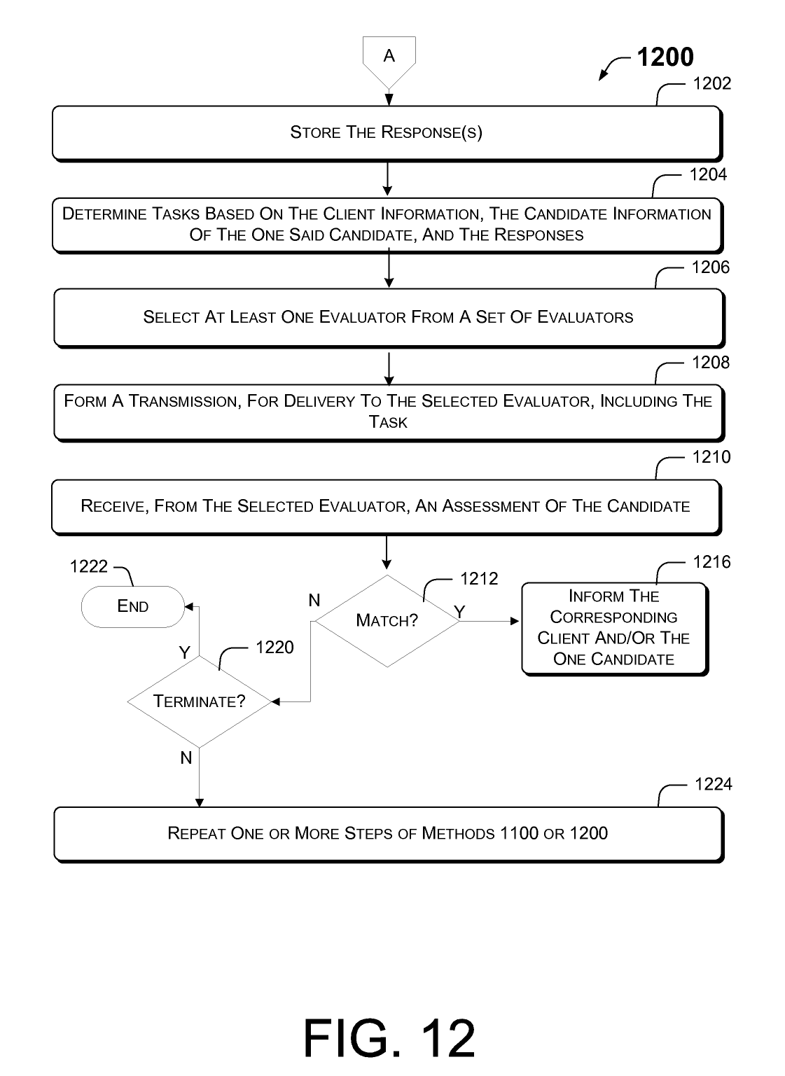

By way of illustration, FIGS. 11 and 12, summarizes Applicant's method 1100, which continues to method 1200, for selecting one or more candidates for an occupational activity. The methods 1100 and 1200 can also be used for other activities (e.g., marketing survey), such as those not associated with an occupation vacancy. At step 1102 client information about an occupational activity is received from a client device of at least one client. The client information may include a job description, a start date, a salary range, a geographic location for the occupational activity, or other parameters that describe the occupational activity, for example. The client information may include a set of queries related to the occupational activity. In one embodiment, the client information includes a client criterion that is usable to select a potential candidate for the occupational activity. For example, the client information may include a ranking or weight for the client queries or parameters that describe the occupational activity. As stated previously, the client information may include a client's sentiments, such as, sentiment's for the question or a context of the question. At step 1104, candidate information about a career aspiration of at least one candidate is received from at least one corresponding candidate device. The candidate information may include a resume, a geographic location in which the career aspiration can be practiced, an expected salary, a type of occupation, a start date, or queries of the candidate, for example.

In some embodiments, the client information and/or the candidate information is received via an interactive user interface that can be rendered on a browser enabled device, such as the client device or the candidate device. To illustrate, a candidate may enter the candidate information into a form communicated to the candidate device via the communication fabric 140 (e.g., the Internet) and rendered on a display of candidate device.

At step 1106, at least one candidate is automatically selected as a potential match for further action using the client information, the candidate information, and/or a preset criterion. The preset criterion may be based on the client criterion included in the client information, a criterion communicated by the candidate in the candidate information, or other preset criterion determined by the qualification processing system (e.g., the qualification processing system 10 of FIG. 1). To illustrate, the qualification processing system may rank a geographical location match between the occupational activity and the geographical location of the career aspiration of the candidate above a match between the occupational activity requested years of experience and the years of experience of the candidate included in the candidate information.

At step 1108, a set of queries are autonomically generated based on the client information and/or the candidate information of the selected candidate of step 1106. Here, the queries within the set of queries may be tailored for the specific clients or for the specific selected candidate. For example, one of the queries within the set of queries may be to further inquire into an experience of the selected candidate based on the candidate information depicted in the resume of the selected candidate. Alternatively, or in combination, as depicted in FIG. 2, the candidate or the client may have identified questions (e.g., question set 210) that become part of the set of queries.

At step 1110, the selected candidate accesses the qualification processing system, such as the qualification processing system 10 of FIG. 1, via the communication fabric 140 for an information session. In one embodiment, the selected candidate is authenticated before access is provided. For example, the selected candidate may enter a unique user ID or password to access the qualification processing system 10.

At a step 1112, a transmission is formed for delivery to the candidate device of the selected candidate. The transmission may include one or more of the queries in the set of queries. At a step 1113, a response to the one or more queries is received from the candidate device of the selected candidate.

At a step 1114, a determination is made whether the client should intervene in the information session. If the client is to intervene, the method 1100 moves from the step 1114 to step 1116. A transmission is sent to the client including a request for further instruction and the candidate information and/or the response to the query. At step 1116, the client provides instructions to the qualification processing system. If the client instructions includes termination of the information session, method 1100 moves from step 1116 to step 1122 and the information session ends at step 1122. If the clients instructions include instructions to continue with the information session, the method 1100 moves from step 1120 to step 1118. Alternatively, or in combination, the client instruction may be to go back (not shown in FIG. 11) to step 1106 in which a determination is made if the selected candidate is a potential match for the occupation activity. If the client is not to intervene at step 1114, the method 1100 moves from the step 1114 to step 1118. Here, if no further queries are to be asked of the selected candidate, the method 1100 moves to the step 1202 of FIG. 12. Alternatively, if another query is to be transmitted to the selected candidate, the method 1100 moves from step 118 to the step 1124. At step 1124, a determination is made if the set of queries should be altered (e.g., add a new query, change an existing query, or delete a query in the set of queries). If the set of queries is not to be altered, the method 1100 moves back to step 1112. Alternatively, if the set of queries is to be altered, the set of queries is altered at step 1126 and the method 1100 moves from step 1126 back to step 1112. Portions of the method 1100 is then repeated until the method 1100 moves to step 1202 of method 1200 in FIG. 12 via off page reference A.

Referring to FIG. 12, the method the 1200 continues the steps of the method 1100 via off page reference A. At a step 1202, the responses to the queries is stored in a database. At a step 1204, tasks are determined based on the client information, the candidate information, and/or the response of the selected candidate. At a step 1206, at least one evaluator from a set of evaluators is selected. At a step 1208, a transmission is formed for delivery to the selected evaluator, including the task determined at step 1204. At a step 1210, an assessment of the candidate based on the task is received from the selected evaluator. At a step 1212, a determination is autonomically made if the selected candidate is a potential match for the occupational activity base don the client information, the candidate information, the response, and/or the assessment received from the selected evaluator. If a match is not found, and the method 1200 is to be terminated at step 1220, the method 1200 ends at step 1222. If the method 1200 is not to be terminated at step 1220, the method continues to step 1224 in which one or more steps of the methods 1100 or 1200 is repeated. Alternatively, if a match is found at step 1212, the method 1200 moves to step 1216 in which the corresponding client and or candidate is informed of the results of the valuation. Any or all of the steps in methods 1100 and 1200 may be repeated or practiced in any order, not necessarily shown.

In other embodiments, methods 1100 and 1200 are used to autonomically evaluate responses of a set of candidates to queries regarding an activity of a client. The set may include one candidate or a plurality of candidates. A set of tasks for evaluating the responses of the candidates are determined. The tasks are allocated to a plurality of evaluators that are unaffiliated to the client. The evaluators assess the responses and send a corresponding assessment of the responses based on the task them back to the qualification processing system. The qualification processing system, in turn, autonomically evaluates the responses based at least in part on the assessment of the evaluators.

For illustrative purposes only, the following describes steps for an exemplary process for use with the qualification processing system 10 of FIG. 1:
The client provides a list of responders or configures a method to acquire multiple responders;
Background information is collected about the client and the responder, wherein the background information comes from the client, the responder, third party, or combination thereof;
The interaction, the query and the criteria to evaluate the interaction are configured;
The interaction is configured by one or more of: the client, the responder, the third party, or the qualification processing system itself, whether manually or algorithmically or both;
The interaction occurs between the system and the responder;
Interaction can be in text, voice, video, etc, and can consist of any combination of these parts (e.g., first text, then voice, then text, then video, etc.);
Interaction can be triggered by the responder calling in, clicking to start, sending a text message based on the information received in an email, voice mail, phone call, print materials, QR code, etc, or by the client via same variety of methods;
Responder's responses to the querying are recorded and analyzed;
Analysis is based on the client criteria & background information, responder's background information, system machine learning or any combination of the above; and is performed by a crowdsourcing algorithm, a machine learning algorithm, or a combination, for example;
Further action is automatically and/or autonomically determined, based on the client pre-set configuration and/or algorithmically;
Further action can be another interaction or a determination or a transaction (e.g., transferring the call to customer support, emailing a coupon, scheduling a face-to-face interview, placing the responder into the sales leads queue system); and
The client and/or the responder are notified and/or have an ability to observe, give feedback on, and share the process and its results.

By way of example, and not by limitation, the following illustrates usage of the qualification processing system 10 for evaluation of client activities:
A restaurant owner registers with the qualification processing system, creates a customer satisfaction survey that consists of 10 questions (e.g., “Did you enjoy the service?”, “Did you eat in the restaurant or order out?”), selects an option to perform survey over the phone, sets criteria for evaluating the responses to the questions (e.g., “Does the person sound angry?”, “Did the person purchase an in-restaurant meal or a meal to-go?”), and provides instructions for follow-up action. Restaurant owner selects an option to generate QR code as the trigger for the interaction, and receives a picture to embed in his receipts.
A consumer visits a restaurant & purchases a meal. Upon payment, the consumer receives a receipt, on which the QR code appears. The consumer scans the QR code with the consumer's mobile device, and receives a link. Clicking on the link initiates consumer's call to the qualification processing system. The consumer's phone number becomes a unique identifier for the consumer, and the interaction is determined by the information contained in the QR code. Consumer answers the 10 questions. The qualification processing system records & analyzes the questions based on the pre-set criteria. The consumer's responses are flagged as “unhappy”, and the consumer automatically receives an email with a $10 coupon to the restaurant and an apology.
The restaurant owner is notified daily about the number of the consumers who took the survey, their classification using his pre-set criteria, and a link to the qualification processing system where the restaurant owner can access the audio recordings of the survey, sort the responders by the criteria, give feedback on the analysis, and trigger additional action.

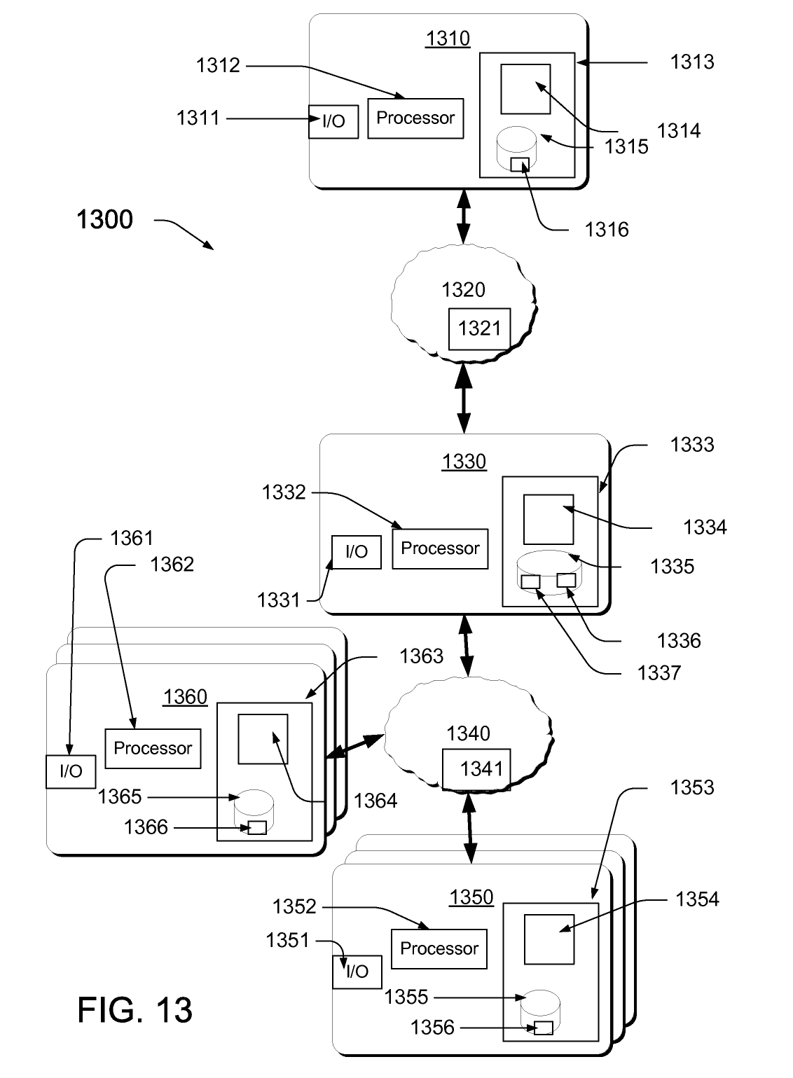

Referring to FIG. 13, a system 1300 for survey response analysis is illustrated. In the illustrated embodiment of FIG. 13, system 1300 comprises a computing device 1330 that is communicatively connected to a computing device 1310 through a first communication fabric 1320, one or more computing devices 1350 through a second communication fabric 1340, and one or more computing devices 1360 through a second communication fabric 1340 or alternatively through the first communication fabric 1320 (not shown) or other communication fabric (not shown). In certain embodiments, the computing device 1330 is a computing device that is owned and/or operated by a host (“host computing device 1330”); the computing device 1310 is a computing device that is owned and/or operated by a client, such as client computing device 160 of FIG. 1; the computing device 1350 is a computing device that is owned and/or operated by a candidate or responder, such as candidate computing device 150 of FIG. 1; and the computing device 1360 is a computing device that is owned and/or operated by an evaluator, such as the evaluator computing device 170 of FIG. 1.

For the sake of clarity, FIG. 13 shows a single computing device 1310, a single computing device 1330, multiple computing devices 1350, and multiple computing devices 1360. FIG. 13 should not be taken as limiting. Rather, in other embodiments any number of entities and corresponding devices can be part of the system 1300, and further, although FIG. 13 shows two communication fabrics 1320 and 1340, in other embodiments less or more than two communication fabrics is provided in the system 1300. For example, in certain embodiments, the communication fabric 1320 and the communication fabric 1340 are the same communication fabric.

In certain embodiments, the computing devices 1310, 1330, 1350, and 1360 are each an article of manufacture. Examples of the article of manufacture include: a server, a mainframe computer, a point of sale device, a signature capture device, a mobile telephone, a smart telephone, a personal digital assistant, a personal computer, a laptop, a set-top box, an MP3 player, an email enabled device, a tablet computer, a punch clock, a web enabled device, or other special purpose computer having one or more processors (e.g., a Central Processing Unit, a Graphical Processing Unit, or a microprocessor) that is configured to execute an algorithm (e.g., a computer readable program or software) to receive data, transmit data, store data, or perform methods.

By way of illustration and not limitation, FIG. 13 illustrates the computing device 1310, the computing device 1330, the computing device 1350, and the computing device 1360 as each including: a processor (1312, 1332, 1352, and 1362, respectively); a non-transitory computer readable medium (1313, 1333, 1353, and 1363, respectively) having a series of instructions, such as computer readable program steps encoded therein; an input/output means (1311, 1331, 1351, and 1361, respectively) such as a keyboard, a mouse, a stylus, touch screen, a camera, a scanner, or a printer. The non-transitory computer readable mediums 1313, 1333, 1353, and 1363 each include corresponding computer readable program code (1314, 1334, 1354, and 1364, respectively) and data repository (1315, 1335, 1355, and 1365, respectively). The processors 1312, 1332, 1352, and 1362 access the computer readable program codes (e.g., 1314, 1334, 1354 and 1364), encoded on the corresponding non-transitory computer readable mediums (1313, 1333, 1353, and 1363, respectively), and execute one or more corresponding instructions (1316, 1336, 1356, and 1366, respectively). In certain embodiments, the computing device 1310, 1330, and 1350 employ hardware and/or software that supports accelerometers, gyroscopes, magnetometers, and the like.

In an example, the processors 1312, 1352, and 1362 access corresponding Application Program Interfaces (APIs) encoded on the corresponding non-transitory computer readable mediums (e.g., 1313, 1353, and 1363, respectively), and execute instructions (e.g., 1316, 1356, and 1366, respectively) to electronically communicate with the computing device 1330, for example. Similarly, the processor 1332 accesses the computer readable program code 1334, encoded on the non-transitory computer readable medium 1333, and executes an instruction 1336 to electronically communicate with the computing device 1310 via the communication fabric 1320 or electronically communicate with one or more computing device 1350 and/or computing device 1360 via the communication fabric 1340. A log 1337 is maintained of the data communicated or information about the data communicated (e.g., date and time of transmission, frequency of transmission . . . etc.) with any or all of the computing device 1310, 1350, and the computing device 1360. In certain embodiments, the log 1337 is analyzed and/or mined.

In certain embodiments, the data repositories 1315, 1335, 1355, and 1365 each comprises one or more hard disk drives, tape cartridge libraries, optical disks, combinations thereof, and/or any suitable data storage medium, storing one or more databases, or the components thereof, in a single location or in multiple locations, or as an array such as a Direct Access Storage Device (DASD), redundant array of independent disks (RAID), virtualization device, . . . etc. In certain embodiments, one or more of the data repositories 1315, 1335, 1355, and 1365 is structured by a database model, such as a relational model, a hierarchical model, a network model, an entity-relationship model, an object-oriented model, or a combination thereof. For example, in certain embodiments, the data repository 1335 is structured in a relational model that stores a plurality of past payment transactions for each of a plurality of candidates as attributes in a matrix.

In certain embodiments, the computing devices 1310, 1330, 1350, and 1360 include wired and/or wireless communication devices which employ various communication protocols including near field (e.g., “Blue Tooth”) and/or far field communication capabilities (e.g., satellite communication or communication to cell sites of a cellular network) that support any number of services such as: telephony, Short Message Service (SMS) for text messaging, Multimedia Messaging Service (MMS) for transfer of photographs and videos, electronic mail (email) access, or Global Positioning System (GPS) service, for example.

As illustrated in FIG. 13, the communication fabrics 1320 and 1340 each comprise one or more switches 1321 and 1341, respectively. In certain embodiments, at least one of the communication fabrics 1320 and 1340 comprises the Internet, an intranet, an extranet, a storage area network (SAN), a wide area network (WAN), a local area network (LAN), a virtual private network, a satellite communications network, an interactive television network, or any combination of the foregoing. In certain embodiments, at least one of the communication fabrics 1320 and 1340 contains either or both wired or wireless connections for the transmission of signals including electrical connections, magnetic connections, or a combination thereof. Examples of these types of connections include: radio frequency connections, optical connections, telephone links, a Digital Subscriber Line, or a cable link. Moreover, communication fabrics 1320 and 1340 utilize any of a variety of communication protocols, such as Transmission Control Protocol/Internet Protocol (TCP/IP), for example.

In certain embodiments, the computing device 1330 provides access to the computing devices 1310, 1350, and/or 1360 to execute the computer readable program 1336 via a Software as a Service (SaaS) means. In certain embodiments data is received from one or more computing devices 1310, 1350, and/or 1360 and stored on the “Cloud” such as a plurality of data storage libraries. Each of the data repositories having corresponding physical storage devices. In certain embodiments, data storage libraries are configured in a Peer To Peer Remote Copy (“PPRC”) storage system, wherein the data in a first data storage library is automatically backed up in another data storage library. In certain embodiments, Applicants' PPRC storage system utilizes synchronous copying.

In certain embodiments, one or more of the computing devices 1310, 1330, 1350, and 1360 exchange data with other computing devices not shown in FIG. 13. For example, in certain embodiments, a transaction processing system is in communication with one or more of the computing devices depicted in FIG. 13. To illustrate, an exemplary computing device 1350 is a point of sale device that is communicatively connected to a computing device of an acquirer (bank of a merchant) which is, in turn, communicatively connected to an issuer of a payment account of a candidate. During a transaction at the point of sale device, an authorization request is sent to the issuer for approval of the transaction via the acquirer. The authorization request includes, a time of day, a date, a payment account number, an identifier of the merchant, a Universal Purchase Code (UPC) or Stock Keeping Unit (SKU) of a product, and a purchase price, for example. A authorization response is sent back from issuer to the point of sale. Here, at any point of during the transaction, the data associated with the transaction is sent to the computing device 1330. For example, the data associated with the transaction, such as the data in the authorization request or the authorization request, is sent to the computing device 1330 from at least one of: the point of sale device, the computing device of the acquirer, and from the computing device of the issuer.

In certain embodiments, a responder to a survey (sometimes referred to as “survey responder”) is selected from a plurality of candidates. The responder is queried to participate in a survey in order to assess the responder's impressions about a topic, such as the responder's impressions of a good or service of a retailer, the responder's impressions on a work environment or business goal (enthusiasm from up-and-coming products) of an employee, the responder's political stance with respect to an identified politician, the responder's intent to vote, or the like. In certain embodiments, the responder is incentivized by a rewarded for participating in the survey (e.g., frequent flyer points or gift certificate).

The responder that has consented to participate in the survey, is then contacted at a predetermined time and the corresponding responses of the responder is recorded in a media rich medium. The media rich medium includes the content of the response of the responder and further includes at least one of a vocal tone, cadence, diction, accent, a facial expression, and body language of the responder. An electronic file of the responses of the responder are encoded at a data repository.

A plurality of evaluators, in turn, utilize corresponding computing devices to access the electronic file. The evaluators review the recorded responses and provide an analysis of a disposition of the responder, such as the responder's positive or negative disposition towards the client or the client's goods or services. In certain embodiments, the analysis of the evaluator includes the evaluator's selections from a set of predefined potential answer options (e.g., a question with multiple choice answers). An overall assessment of the responder's disposition is made, such as by a statistical combination of the evaluators' selections. The overall assessment of the responder's disposition is included in a report to the client.

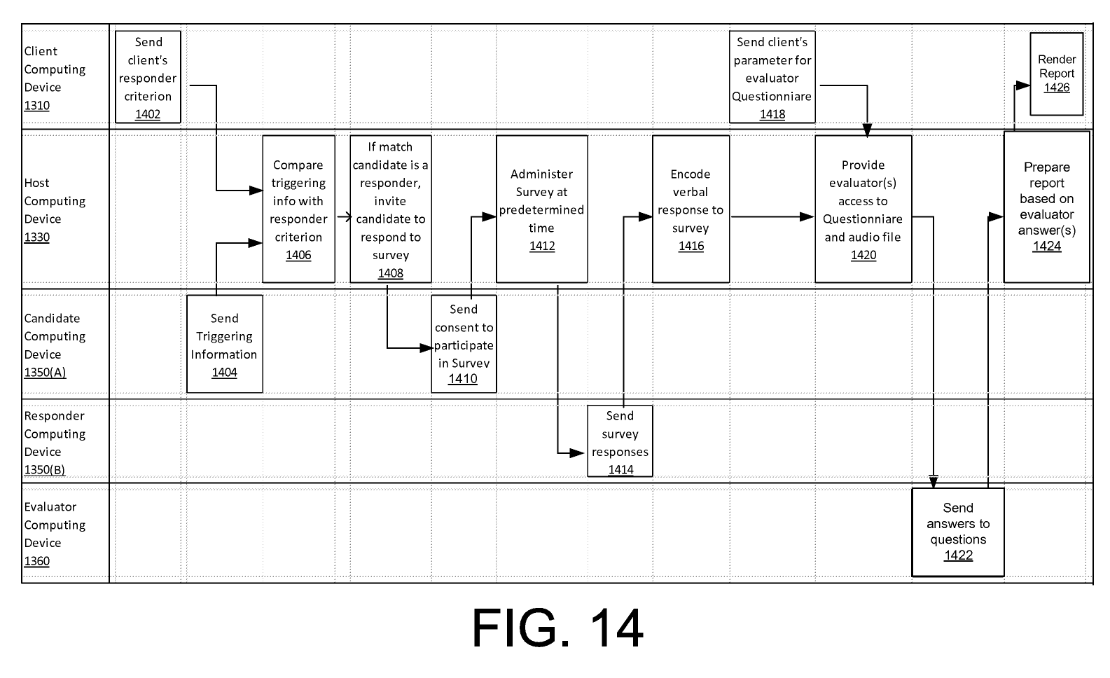

Referring to FIGS. 13 and 14, a cross functional flow chart illustrates a flow of information between the computing devices of the system of 1300 of FIG. 13 and/or system 100 of FIG. 1, for example. In certain embodiments, the candidate computing device 1350(A) is the same as the responder computing device 1350(B). For example, the candidate computing device 1350(A) is a smart phone the candidate used to make an on-line purchase and the responder computing device 1350(B) is the same smart phone that is then called to conduct a subsequent survey. In another example, the candidate computing device 1350(A) is the different from the responder computing device 1350(B). For example, the candidate computing device 1350(A) is a point of sale device at a retailer's store and the responder computing device 1350(B) is a telephone of the candidate.

At step 1402, a client uses the client computing device 1310 to enter a responder criterion for selecting a responder from a plurality of candidates to participate in a survey. For example, the client is interested in knowing the disposition of candidates that are: 40 years of age or older and have purchased deodorant at retail stores located in Los Angeles, Calif. Here, the client enters, at a user interface of the client computing device 1310, the following criteria: Age—40 or older years of age; Action—purchase deodorant; Geographic Scope—Los Angeles, Calif. Other criteria are also contemplated, for example, in another embodiment, a responder criterion is a past transaction history of the candidate, such as frequency of payment transactions at a store of a merchant, an average purchase price of past transactions over a predetermined time period, or a repeat purchase of an identified product of the merchant. In yet another embodiment, the responder criterion is based in part, on data received from a third party source that is then encoded at the data repository 1335, such as, a Fair Isaac Corporation (FICO) score of the candidate. The client computing device 1310 sends the responder criteria for delivery to the host computing device 1330 via the communication fabric 1320, which host computing device 1330 encodes the responder criteria at the data repository 1335.

At step 1404, a candidate computing device 1350(A) sends triggering information, which is then received by the host computing device 1330. In certain embodiments, the triggering information is related to an activity of the candidate, such as conducting a payment transaction, printing a boarding pass for a flight, punching in on a punch clock, making a phone call, accessing a website, a combination thereof, . . . etc. For example, a candidate computing device 1350(A), which is a point of sale device or a signature capture device, sends triggering information that is related to a payment activity of the candidate, such as data associated with a payment authorization request for a payment transaction of the candidate. Here, the triggering information includes a payment account number, date of birth, a SKU, a location of the merchant, and the purchase price for the transaction, each of which is received by the host computing device 1330.

At step 1406, the host computing device 1330 compares the triggering information received from step 1404 to the responder criterion. If a match is not found, the candidate is not invited to participate in the survey. On the other hand, if a match is found, the candidate is considered a responder and an invitation is sent to the candidate to respond to the survey at step 1408. For example, data is sent back to the point of sale device or signature capture device to be rendered on a user interface that displays the invitation to the candidate. In another example, data is sent back to the point of sale device to be rendered a user interface that displays the invitation to a cashier or retailer attendant that, in turn, conveys the invitation to the candidate. In certain embodiments, the invitation is incentivized such that the candidate is offered a reward for participating in the survey. For example, the candidate is offered cash back on the pending purchase, a preloaded gift card, frequent flyer miles, a good or service of the merchant, a discount at a third party retailer, a combination of the forgoing, and the like.

At step 1410, the candidate/responder consents to participate in the survey. For example, the candidate/responder selects an opt-in option displayed at the user interface of the candidate computing device 1350(A), which is sent back to the host computing device 1330. In certain embodiments, the consent includes instructions for communicating with the candidate/responder to conduct the survey. For example, the candidate/responder provides a telephone number to the responder computing device 1350(B) at which the candidate/responder can be subsequently contacted, or provides a time that the candidate/responder will be available to respond to the survey.

At step 1412, the survey is administered (e.g., conducted). For example, the responder receives a phone call at a phone number provided by the responder at step 1410. The survey is then conducted such that the responder is queried about a topic of interest to the client. For example, the responder is queried about a quality of a product just purchased from a merchant. Here, the responder is asked “why did you select to purchase the that brand of deodorant at your recent purchase?” or “what do you find satisfactory about your job” or “what should be the next president's top priority for the country?” Other examples of queries include:
If you were to recommend this store to a friend or family member, what would you say?
Please tell me how you heard about this retail store
What was most memorable about your visit today?
Did you do any research before buying this product today? If so, where else did you look?
You've just bought one of our products, and we wanted to ask you why you chose to purchase it from this retail store?
If this retail store were to close, how would you feel?

In certain embodiments, one or more queries in the survey are open ended having unstructured potential responses, such that the responder is not required to select from predefined answers to the query. For example, the responder is given an opportunity to respond in a stream of consciousness fashion. In certain embodiments, the survey is administered automatically. For example, a prerecorded or machine read set of queries are telephonically conveyed to the responder.

In certain embodiments, the host computing device 1330 determines a predetermined time to administer the survey based on a contacting rule. For example, the predetermined time is determined based a contacting rule aimed at contacting the responder at a time when the data is most relevant to the client or a time that the activity being measured is freshest in the mind of the responder, such as right after (e.g., within minutes after) a payment transaction is completed. In certain embodiments, the predetermined time is determined based on the triggering information received from step 1404. To illustrate, the candidate computing device 1350(A) is a self-service kiosk at an airline check in counter of a client that is an airline. The triggering information of step 1404 is data about a subsequent flight. Here, the contacting rule dictates that the survey that are consented to (step 1410) from a self-service kiosk at an airline check-in counter should be administered 15 minutes after the subsequent flight has landed at its destination. The client uses the client computing device 1310 to send flight status information for the airline to the host computing device 1330 (not shown). Once the flight status information indicates that the subsequent flight has landed, the host computing device 1330 administers the survey at step 1412.

At step 1414, the responder computing device 1350(B) sends the responses to the survey, which are ultimately received by the host computing device 1330. For example, the responder provides a verbal response to the queries of the survey and telephonically sends the verbal response to an agent of the host that, in turn, sends the verbal response to the host computing device 1330. Alternatively, or in combination, an audio/visual image and file is sent from the responder computing device 1350(B), such as a tablet with a camera, to the host computing device 1330.

At step 1416, the response of the responder is encoded, such as, at the data repository 1335. For example, a verbal response is encoded as an audio file, a video file, or a combination thereof at the data repository 1335. To illustrate, a telephonic administration of the survey at step 1412 is recorded as an audio file and sent to the host computing device 1330, which encodes the audio file. In certain embodiments, the recording is transcribed, transliterated, and/or translated and the corresponding file is encoded in the at the data repository 1335.

At step 1418, the client defines parameters for evaluators. For example, the client is interested in whether its shoppers leave its retail establishment feeling satisfied that they have received value for their money or whether the shoppers leave feeling angry. Here, the client would enter parameters of “satisfied” or “angry” into a user interface of the client computing device 1310, which is, in turn, sent to the host computing device 1330.

In certain embodiments, the host computing device 1310 creates a structured questionnaire for the evaluators. The structured questionnaire includes one or more questions each having a plurality of predefined answers, such as True or False answers or multiple choice answers. For example, the questionnaire includes a question: “would you describe the tone of the responder as: supportive, unenthusiastic, fed up, or frustrated?” “based on the speed of response of the responder, would you say the responder is sure of his response: yes or no?” “based on the diction of the responder's response, would you say the responder is a bottom-line type person?” “looking at the pupils of the responder in the video, would you say the responder is saying the truth, yes or no?”

At step 1420, one or more evaluators is given access to the encoded verbal response of step 1416 and the questionnaire. For example, a set of forty non-expert evaluators log onto a private website of the host using respective user identifiers and passwords. The evaluators select from user interface options to access the verbal response encoded as an audio file in step 1416 and the questionnaire. In certain embodiments, the set of evaluators includes: between ten to twenty evaluators; between twenty to fifty evaluators; between fifty to one hundred evaluators; between one hundred to five hundred evaluators; and between five hundred to one thousand evaluators.

At step 1422, the evaluators use respective evaluator computing devices 1360 to provide and/or select answers to questions within the questionnaire about the disposition of the responder. For example, the evaluator selects answers (“selected answers”) to questions of the questionnaire that each have a plurality of predefined potential answers. For example, a first evaluator selects that the responder was “frustrated” when answering a first query of the survey while a second evaluator selects that the responder was “unenthusiastic” when answering the first query. Here, the selected answers of both the first evaluator and the second evaluator are each sent and ultimately received by the host computing device 1330.

In certain embodiments, the evaluators have an option to flag the response of the responder to indicate that further action should be taken. For example, the first evaluator in the above example flags the response of the responder as frustrated and adds text “the responder should be contacted soon with an apology from the retailer at which the responder shopped.” Here, the client is promptly notified of the responder's frustration so that the client can take corrective action. For example an alert is immediately sent to the client computing device 1310 or other computing device of the client. In certain embodiments, the evaluators authenticated the response and flag responses that are not authenticated. For example, after listening to the recorded response, the evaluator enters text into a user interface rendered on the evaluator computing device 1360 indicating “the responder's voice does not match the demographic of the candidate that consented to participating in the survey; the candidate sounds to be about 10 years old while the consenting candidate is listed as 45 years old. The phone number of the responder should be confirmed and a subsequent call should be made.” Here, the data about the responder stored in the data repository 1335 is checked and a subsequent teleconference is automatically rescheduled to conduct the survey using a confirmed phone number.

In certain embodiments, the system 1300 supports interactive evaluation. For example, if a first evaluator selects an answer in the questionnaire indicating the corresponding responder's disposition was “negative,” then a second evaluator, which may be the same or different evaluator than the first evaluator, is queried about the next best step to deal with the “negative” disposition of the responder. For example, the second evaluator selects from predefined next actions, such as selecting between the options of: “(A) send a $10 gift card; (B) send an apology to the responder; (C) give the responder a gift certificate; and (D) all of the above. In certain embodiments, if a plurality of evaluators select different next actions, then the next action that was most frequently selected is automatically taken. calculate if there's an agreement about certain action and if so trigger it automatically,

In another example, one or more evaluator tag each response with a word that comes to his/her mind when listening to the response. The similar or matching tags are then batched together to groups to extract insight that wasn't included in the spoken words of the respondent but could be implied with high degree of confidence. For example, one or more evaluators select “confused responder” from a set of predefined terms or type in the term “confused responder” that is then stored in association with the audio file encoded at the data repository 1335. The host computing device 1330 then batches data associated with the responses having the tag “confused responder” and statistically analyzes or mines the batched data to determine if there is a trend within the batched data.

At step 1424, the answers of the evaluators to the questionnaire is collected, saved, and analyzed by the host computing device 1330. For example, the selected answers of the evaluators are: statistically analyzed or mined to determine averages or trends, to predict future responses, or compared to known business goals of the corresponding client. At step 1426, the report is made available to the client. For example, the client computing device 1310 renders a user interface that allows the client to review the report created in step 1424. In certain embodiments, the client further has access to the recordings stored at step 1416.

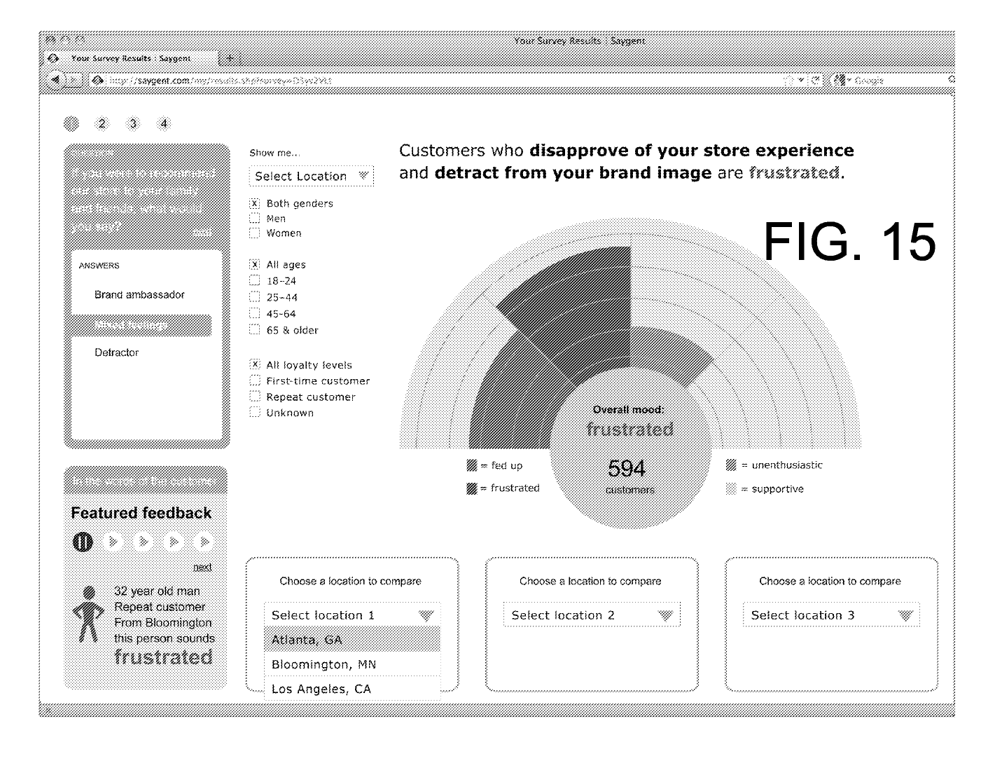

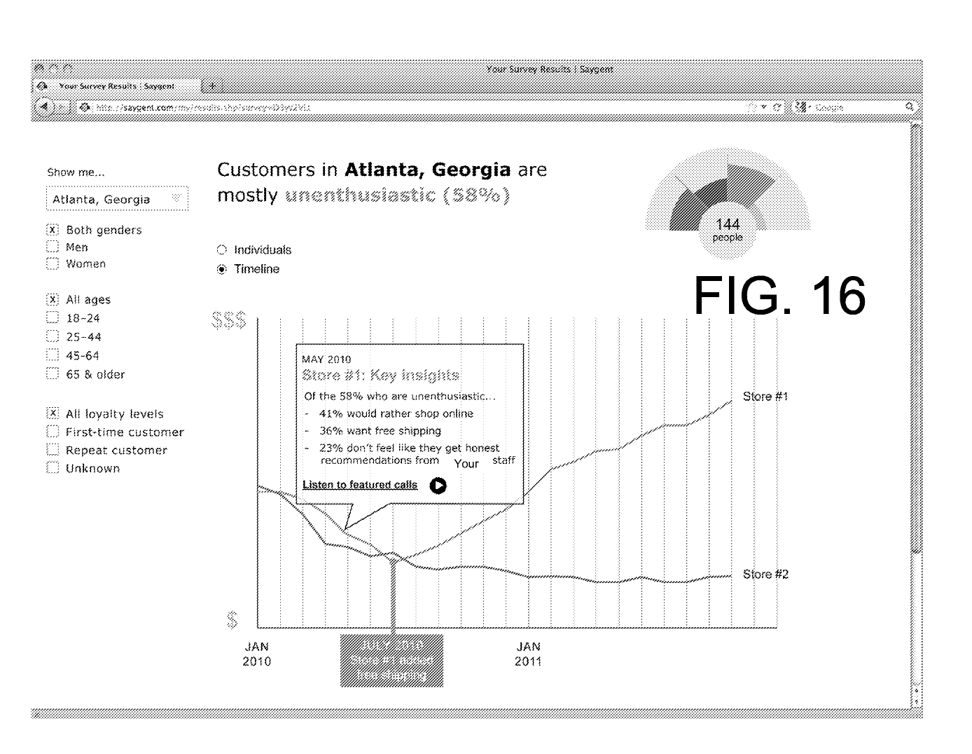

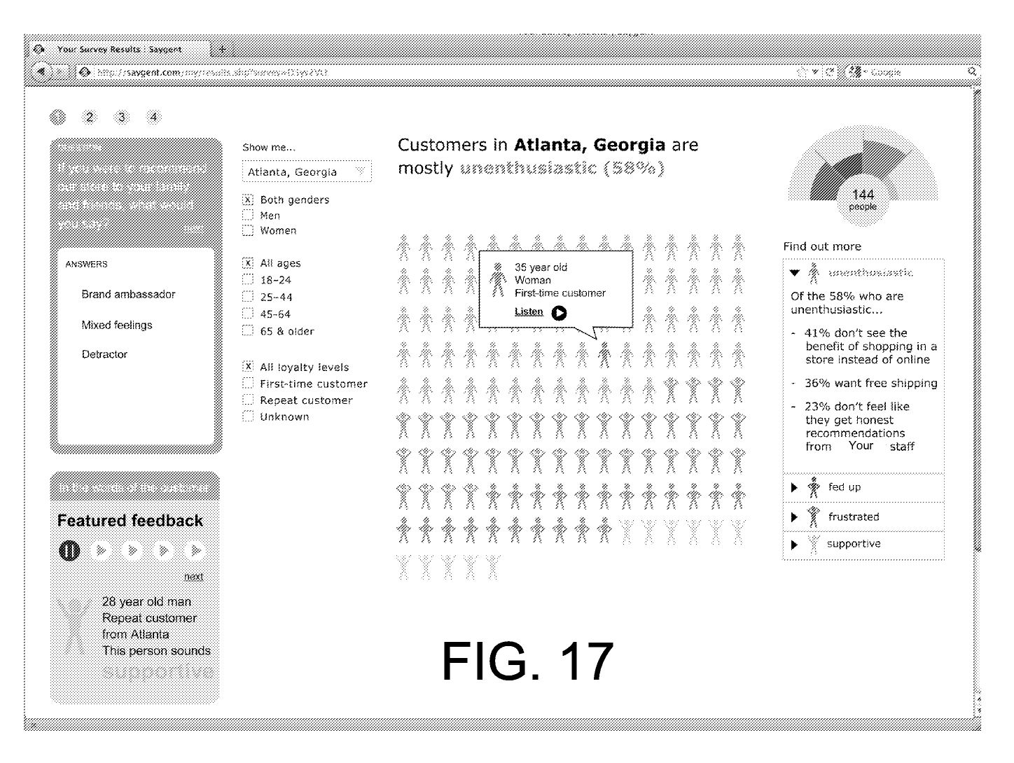

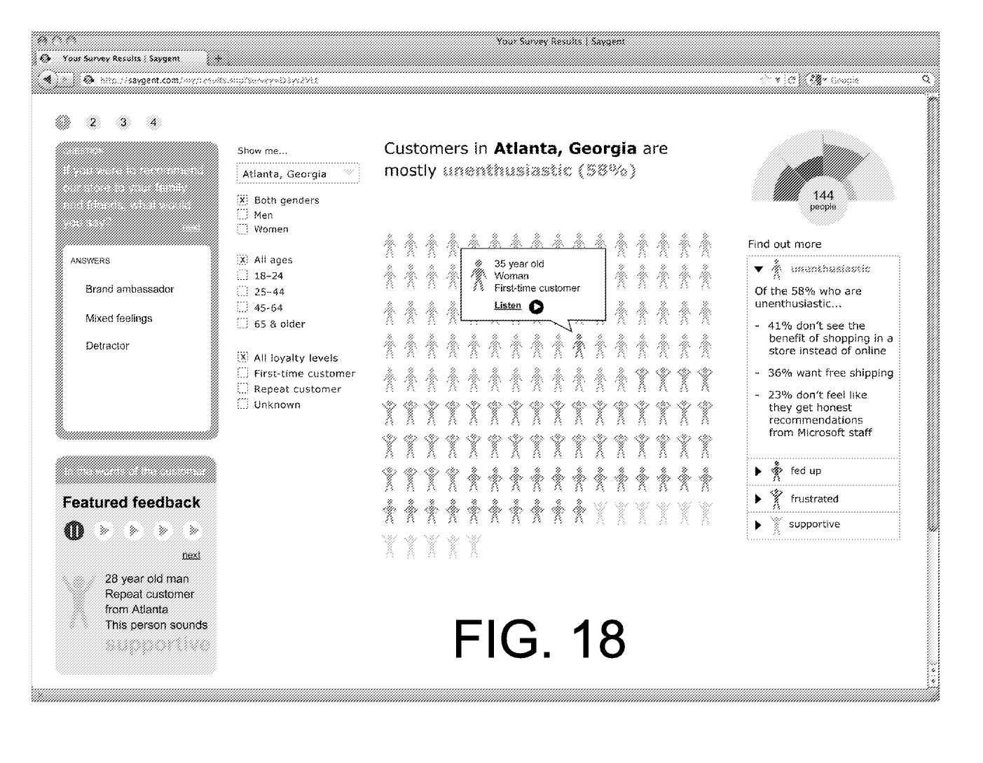

FIGS. 15-18 show exemplary screen shots of the reports rendered on the client computing device 1310. FIG. 15 is a screen shot of a user interface that gives the client access to the recorded responses of the responders and evaluator's corresponding assessments. Here, the client has the option to filter the data based on age, location, and predefined dispositions. FIG. 16 is a screen shot illustrating a result of the evaluators' selections in comparison to a known business activity “July 2010 Store #1 added free shipping” on a timeline. FIGS. 17 and 18 each include a screen shot illustrating a functionality in which the client can zoom in on each store's disposition metric.

In certain embodiments, the processor responder receives a notification when a response of that responder is accessed and/or evaluated by, for example, an evaluator and/or client. For example, when one or more evaluator access the recorded response of the responder, the responder computing device 1350(B) receives a transmission including a notification that the response of the responder is being reviewed. To illustrate, one of the evaluators is a Chief Executive Officer of a retail store. When the CEO accesses the audio file of the response to the survey of a first responder, the first responder automatically receives a text message addressed to the responder's phone (responder computing device 1350(B)) indicating “Thank you for participating in our survey about our retail stores yesterday. The CEO of the retail store has just reviewed your responses. You are an import customer and we value your suggestions.”

In some embodiments, one or more portions of the qualification processing system 10 can include a hardware-based module (e.g., a digital signal processor (DSP), a field programmable gate array (FPGA)) and/or a software-based module (e.g., a module of computer code, a set of processor-readable instructions that can be executed at a processor). In some embodiments, one or more of the functions associated with, for example, the qualification processing system 10 can be performed by different modules and/or combined into one or more modules.

In certain embodiments, individual steps recited in FIGS. 2-7, 9-12, and/or 14 may be combined, eliminated, or reordered.

In certain embodiments, computer program readable code, such as instructions 196 (FIG. 1), resides in non-transitory computer readable medium 194 (FIG. 1), wherein those instructions are executed by a processor, such as processor 192 (FIG. 1), and/or 142 (FIG. 1), to perform one or more of steps recited in FIGS. 2-7, 9-12, and/or 14.

In certain embodiments, a non-transitory processor-readable medium stores code representing instructions that when executed cause a processor to define, in a memory, an interview question based at least in part on one or more of: a position requirement and a candidate resume. The code can further represent instructions that when executed cause the processor to receive, based on the interview question, a signal including a response to the interview question. The code can further represent instructions that when executed cause the processor to store, at the memory, the response to the interview question. Here, a non-transitory processor-readable medium stores code representing instructions that when executed cause a processor to: define, in a memory, an interview question based at least in part on one or more of: a position requirement; and a candidate resume. The processor-readable medium stores code further representing instructions that when executed cause a processor to receive, based on the interview question, a signal including a response to the interview question; and to store, at the memory, the response to the interview question. In certain embodiments, the interview question is a first interview question, the response to the interview question is a response to the first interview question, and the signal is a first signal. In certain embodiments, the code further represents instructions that when executed cause the processor to: select, based at least in part on the response to the first interview question, a second interview question from a set of interview questions; receive, based on the second interview question, a second signal including a response to the second interview question; and store, at the memory, the response to the second interview question. In certain embodiments, the code further represents instructions that when executed cause the processor to: send, in response to the response to the first interview question, an alert signal, the alert signal including an instruction to: initiate a test of a first candidate; request that the first candidate exit an interview; and invite a second candidate to join the interview.

In other embodiments, the invention comprises computer readable program code residing in any other computer program product, where that computer readable program code is executed by a computer external to, or internal to, system 10 (FIG. 1) and/or system 1300 of FIG. 13, to perform one or more of steps recited in FIGS. 2-7, 9-12, and/or 14. In either case, the computer readable program code may be encoded in a non-transitory computer readable medium comprising, for example, a magnetic information storage medium, an optical information storage medium, an electronic information storage medium, and the like. “Electronic storage media,” may mean, for example and without limitation, one or more devices, such as and without limitation, a PROM, EPROM, EEPROM, Flash PROM, compactflash, smartmedia, and the like.

Examples of computer readable program code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

While various embodiments have been described above, it should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described. For example, multiple, distributed qualification processing systems can be configured to operate in parallel.

Although the present invention has been described in detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein.

We claim:

1. An article of manufacture comprising a processor and a non-transitory computer readable medium having computer readable program code disposed therein to evaluate a response of a survey responder, the computer readable program code comprising a series of computer readable program steps to effect:
encoding an audio file comprising a verbal response of a survey responder to a survey;
providing, to one or more evaluators, access to the audio file;
providing, to the one or more evaluators, a questionnaire comprising a question regarding a disposition of a survey responder in combination with a plurality of predefined answers to the question;
for each said evaluator, receiving one or more selected answers selected from the plurality of predefined answers; and
creating a report based on the one or more selected answers.

2. The article of manufacture of claim 1, wherein the computer readable program code further comprising a series of computer readable program steps to further effect selecting, based on a predefined criterion, the survey responder from among a plurality of candidates.

3. The article of manufacture of claim 2, wherein selecting the survey responder comprises:
receiving triggering information related to an activity of one said candidate;
comparing at least the triggering information with the predefined criterion to find a match; and
when the match is found, forming a transmission including an invitation to the one said candidate to participate in the survey.

4. The article of manufacture of claim 3, wherein the invitation is addressed to a computing device that is selected from the group consisting of: a point of sale device; a signature capture device; a kiosk; a punch clock; mobile telephone; a smart telephone, a personal digital assistant; a personal computer; a laptop; a tablet; and a combination of the foregoing.

5. The article of manufacture of claim 3, wherein the triggering information is a payment authorization request sent from a computing device that is selected from the group consisting of: a point of sale device; a signature capture device; and a combination thereof.

6. The article of manufacture of claim 3, wherein:
selecting the survey responder further comprises comparing a prior payment transaction history of the one said candidate with a second said predefined criterion;
the prior transaction history of the candidate includes prior payment transactions of the candidate within a payment processing system; and
to find a match includes matching the triggering information with the predefined criterion and matching the prior payment transaction history to the second said predefined criterion.

7. The article of manufacture of claim 3, wherein the computer readable program code further comprising a series of computer readable program steps to further effect determining when to contact the survey responder to conduct the survey based on at least the triggering information and a contacting rule.

8. The article of manufacture of claim 2, wherein the computer readable program code further comprising a series of computer readable program steps to further effect receiving the predefined criterion from a client interested in a result of the survey.

9. The article of manufacture of claim 1, wherein the computer readable program code further comprising a series of computer readable program steps to further effect providing a client access to the report.

10. The article of manufacture of claim 1, wherein the one or more evaluators is selected from a group consisting of: between ten said evaluators to twenty said evaluators; between twenty said evaluators to fifty said evaluators; between fifty said evaluators to one hundred said evaluators; between one hundred said evaluators to five hundred said evaluators; and between five hundred said evaluators to one thousand said evaluators.

11. The article of manufacture of claim 1, wherein the audio file includes at least one of: an audio recording; a video recording; and a combination thereof.

13. A computer program product encoded in a non-transitory computer readable medium and useable with a programmable computer processor to evaluate a response of a survey responder, the computer program product comprising:
computer readable program code which causes said programmable processor to select, based on a predefined criterion, a survey responder from among a plurality of candidates;
computer readable program code which causes said programmable processor to receive a verbal response of the survey responder to the survey;
computer readable program code which causes said programmable processor to encode an audio file comprising the verbal response;
computer readable program code which causes said programmable processor to provide, to one or more evaluators, access to said audio file;
computer readable program code which causes said programmable processor to provide, to the one or more evaluators, a questionnaire comprising a question regarding a disposition of the survey responder in combination with a plurality of predefined answers to the question;
computer readable program code which causes said programmable processor to receive, from each of the one or more evaluators, a selected answer selected from the plurality of predefined answers;
computer readable program code which causes said programmable processor to create a report based on the one or more selected answers; and
computer readable program code which causes said programmable processor to provide a client access to the report.

14. The computer program product of claim 13, wherein to select the survey responder comprises:
receiving triggering information related to an activity of one said candidate;
comparing at least the triggering information with the predefined criterion to find a match; and
when the match is found, forming a transmission including an invitation to the one said candidate to participate in the survey.

15. The computer program product of claim 14, further comprising computer readable program code which causes said programmable processor to determine when to contact the survey responder based on at least the triggering information and a predetermined contacting rule.

16. A method for evaluating a response of a survey responder, comprising:
receiving a verbal response of a survey responder to a survey;
encoding an audio file comprising the verbal response;
providing, to the one or more evaluators, access to the audio file;
providing, to the one or more evaluators, a questionnaire comprising a question regarding a disposition of a survey responder in combination with a plurality of predefined answers to the question;
receiving, from each of said one or more evaluators, at least one selected answer selected from the plurality of predefined answers;
creating a report based on the at least one selected answer; and
providing a client access to the report.

17. The method of claim 16, further comprising selecting, based on a predefined criterion, the survey responder from among a plurality of candidates.

18. The method of claim 17, wherein selecting the survey responder comprises:
receiving triggering information related to an activity of one said candidate;
comparing at least the triggering information with the predefined criterion to find a match; and
when the match is found, forming a transmission including an invitation to the one said candidate to participate in the survey.

19. The method of claim 18, wherein the invitation is addressed to be sent to a computing device that is selected from the group consisting of: a point of sale device; a signature capture device; a kiosk; a punch clock; mobile telephone; a smart telephone, a personal digital assistant; a personal computer; a laptop; a tablet; and a combination of the foregoing.

20. The method of claim 17, further comprising determining when to contact the survey responder to conduct the survey based on at least the triggering information and a contacting rule.
